(19) United States
(12) Patent Application Publication
(10) Pub. No.: US 2026/0268426 A1
(43) Pub. Date: Sep. 10, 2026

(54) SYSTEM

(71) Applicant: SoftBank Group Corp., Tokyo (JP)

(72) Inventor: Hiroaki SUGITA, Tokyo (JP)

(21) Appl. No.: 19/073,211

(22) Filed: Mar. 7, 2025

(51) Int. Cl. G06Q 50/18; G06Q 30/0201

(52) U.S. Cl. CPC G06Q 50/184; G06Q 30/0201

(57) ABSTRACT

The system according to the embodiment comprises an analysis unit, a check unit, and an organization unit. The analysis unit analyzes the appropriateness of names. The check unit checks the registrability in various countries or the risk of trademark infringement based on name candidates generated by the analysis unit. The organization unit organizes application information for registration or trademark registration based on the results obtained by the check unit.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, it is difficult to consistently check the appropriateness of names, registrability in various countries, and trademark infringement risks, and efficient procedures are required.

### SUMMARY OF THE INVENTION

The system according to the embodiment comprises an analysis unit, a check unit, and an organization unit. The analysis unit analyzes the appropriateness of names. The check unit checks the registrability in various countries or the risk of trademark infringement based on name candidates generated by the analysis unit. The organization unit organizes application information for registration or trademark registration based on the results obtained by the check unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor with a sign (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) with a sign is a memory where information is temporarily stored and used as a work memory by the processor.

In the following embodiments, a storage with a sign is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) with a sign is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

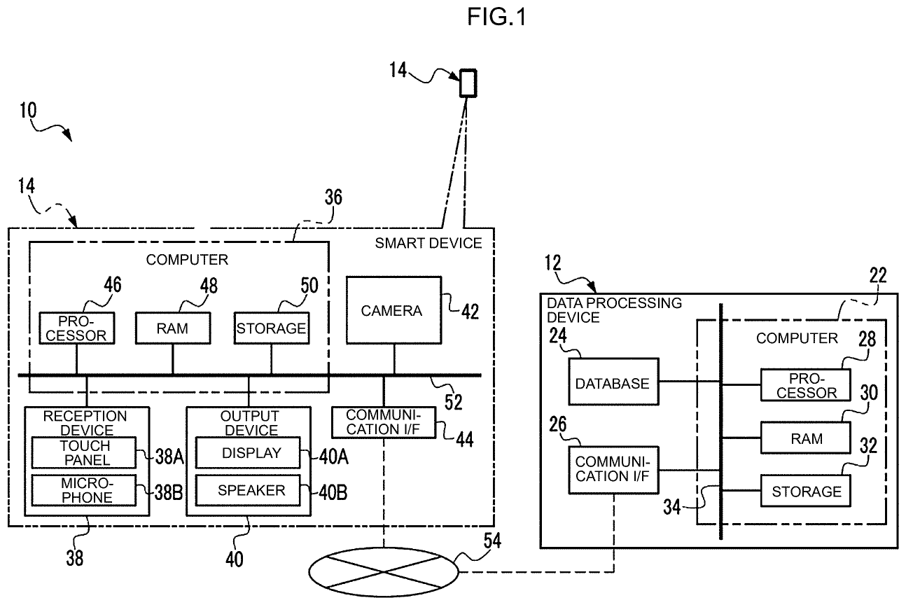

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

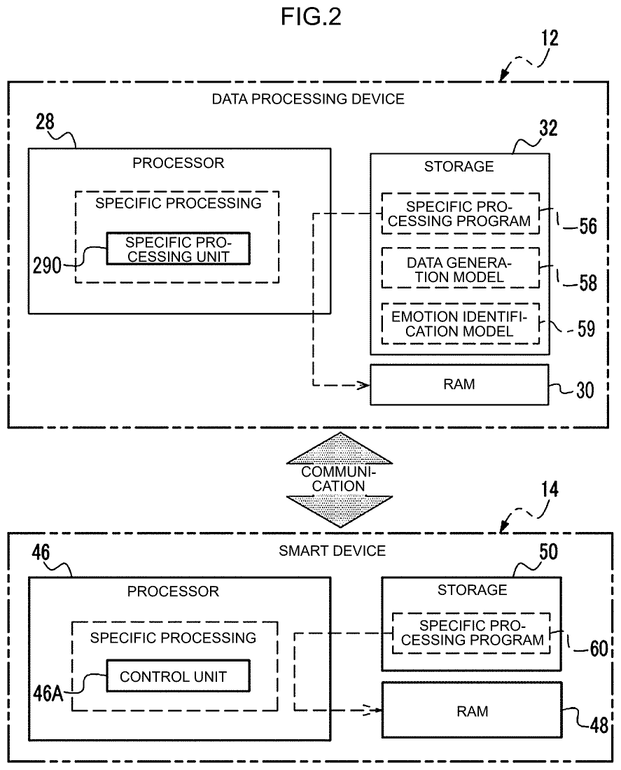

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1 of the Embodiment

The system according to the embodiment is a system that streamlines the consideration and implementation of company names and service names during entrepreneurship, new service development, and new business consideration. This system is composed of the following steps by linking generative AI with related APIs (market research and databases of various countries). First, the user inputs the company name or service name under consideration. Next, the generative AI analyzes the appropriateness of the name (such as its meaning and image) and lists appropriate candidates. During this process, the generative AI refers to market research data and databases of various countries to evaluate the meaning and image of the name. Then, the generative AI checks the registrability in various countries and the risk of trademark infringement. Specifically, it accesses trademark databases and registration databases of various countries through related APIs to confirm whether the input name is already registered or poses a risk of trademark infringement. This result is also listed and provided to the user. Furthermore, the generative AI organizes application information for registration and trademark registration and provides it to the user. This allows the user to proceed with procedures efficiently. For example, by automatically listing necessary documents and procedural steps and providing them to the user, the system aims to streamline procedures. This system contributes to the efficiency of considering and implementing company names and service names during entrepreneurship, new service development, and new business consideration, thereby enhancing the efficiency of planning and procedures. As a result, the system can streamline the consideration and implementation of company names and service names during entrepreneurship, new service development, and new business consideration.

The system according to the embodiment comprises an analysis unit, a check unit, and an organization unit. The analysis unit analyzes the appropriateness of names. The appropriateness of names includes, for example, cultural compatibility, ease of pronunciation, and appropriateness of meaning, but is not limited to these examples. The analysis unit uses generative AI to analyze the meaning and image of names. Generative AI, for example, uses text-generating AI (such as LLM) to evaluate the meaning and image of names. Additionally, the analysis unit can evaluate the appropriateness of names by referring to market research data and databases of various countries using generative AI. For example, generative AI collects relevant market research data and evaluates the meaning and image of names. The check unit checks the registrability in various countries and the risk of trademark infringement based on name candidates generated by the analysis unit. The check unit accesses trademark databases and registration databases of various countries through related APIs to confirm whether the input name is already registered or poses a risk of trademark infringement. For example, the check unit accesses trademark databases of various countries to confirm whether the name is already registered. Additionally, the check unit can access registration databases of various countries to confirm whether the name is registrable. The organization unit organizes application information for registration and trademark registration based on the results obtained by the check unit. The organization unit lists necessary documents and procedural steps and provides them to the user. For example, the organization unit lists the documents required for registration and trademark registration and provides them to the user. Additionally, the organization unit can list procedural steps and provide them to the user. This allows the system according to the embodiment to efficiently check the appropriateness of names, registrability, and trademark infringement risks, and organize application information, enabling efficient consideration and implementation of names.

The analysis unit analyzes the appropriateness of names. The appropriateness of names includes, for example, cultural compatibility, ease of pronunciation, and appropriateness of meaning, but is not limited to these examples. The analysis unit uses generative AI to analyze the meaning and image of names. Generative AI, for example, uses text-generating AI (such as LLM) to evaluate the meaning and image of names. Specifically, generative AI learns from a large amount of text data to analyze the cultural background and historical meaning of names. For example, it can evaluate how a specific name is perceived in a particular culture or region and assess the positive or negative image associated with that name. Furthermore, generative AI can use speech recognition technology to evaluate the ease of pronunciation of names. This allows the analysis of how names are pronounced in different languages and accents, evaluating the ease of pronunciation. Additionally, generative AI can analyze the meaning and related words of names to evaluate the appropriateness of names in specific contexts. For example, it can evaluate how a name is perceived in a particular industry or market. Furthermore, the analysis unit can evaluate the appropriateness of names by referring to market research data and databases of various countries using generative AI. For example, generative AI collects relevant market research data and evaluates the meaning and image of names. This allows the analysis unit to evaluate the appropriateness of names from multiple perspectives and provide optimal name candidates to the user.

The check unit checks the registrability in various countries and the risk of trademark infringement based on name candidates generated by the analysis unit. The check unit accesses trademark databases and registration databases of various countries through related APIs to confirm whether the input name is already registered or poses a risk of trademark infringement. Specifically, the check unit accesses trademark databases of various countries to confirm whether the name is already registered. Additionally, the check unit can access registration databases of various countries to confirm whether the name is registrable. For example, if a specific name is already registered as a trademark, the check unit confirms whether using that name poses legal issues. Additionally, the check unit confirms whether the name is registrable in specific countries or regions and provides the results to the user. Furthermore, the check unit evaluates the risk of trademark infringement by analyzing the degree of similarity between the name and existing trademarks. This allows the evaluation of the risk of confusion with existing trademarks, providing appropriate advice to the user. For example, if the name is similar in sound or spelling to existing trademarks, the check unit evaluates the risk and can propose alternatives to the user. This allows the check unit to quickly and accurately evaluate the registrability and trademark infringement risk of names, providing information to minimize legal risks for the user.

The organization unit organizes application information for registration and trademark registration based on the results obtained by the check unit. The organization unit lists necessary documents and procedural steps and provides them to the user. Specifically, the organization unit lists the documents required for registration and trademark registration and provides them to the user. Additionally, the organization unit can list procedural steps and provide them to the user. For example, the organization unit lists the documents and procedures required for registration and trademark registration in specific countries or regions and provides them to the user in an easy-to-understand manner. This allows the user to prepare the necessary documents without omission and proceed with procedures smoothly. Furthermore, the organization unit can provide document formats and examples to support the user in accurately creating documents. For example, the organization unit provides templates for registration and trademark registration application documents, allowing the user to accurately fill in the necessary information. Additionally, the organization unit can track the progress of procedures and provide timely notifications to the user. This allows the user to grasp the progress of procedures and respond promptly as needed. Furthermore, the organization unit can check and correct the documents submitted by the user to support smooth application processing. This allows the organization unit to support the user in efficiently carrying out registration and trademark registration procedures, increasing the success rate of procedures.

The system comprises a collection unit that collects market research data. The collection unit collects market research data. Market research data includes, for example, consumer surveys, sales data, and competitive analysis, but is not limited to these examples. The collection unit conducts consumer surveys and collects consumer opinions. Additionally, the collection unit collects sales data and analyzes product sales performance. Furthermore, the collection unit conducts competitive analysis to understand the trends of competitors. For example, the collection unit conducts consumer surveys to collect consumer opinions. Consumer surveys are conducted using methods such as online surveys and telephone interviews. Sales data is collected from sources such as POS data and online sales data. Competitive analysis involves collecting and analyzing information from sources such as competitor websites and market reports. This allows the collection unit to collect market research data to more accurately evaluate the appropriateness of names.

The system comprises an access unit that accesses trademark databases and registration databases of various countries. The access unit accesses trademark databases and registration databases of various countries. Trademark databases include, for example, databases of trademark registration agencies in various countries, but are not limited to these examples. Registration databases include, for example, databases of registration agencies in various countries, but are not limited to these examples. The access unit accesses databases of trademark registration agencies in various countries to confirm whether the name is already registered. Additionally, the access unit can access databases of registration agencies in various countries to confirm whether the name is registrable. For example, the access unit accesses databases of trademark registration agencies in various countries to confirm whether the name is already registered. Trademark databases include information such as trademark registration numbers, registration dates, and registrant names. Registration databases include information such as registration numbers, registration dates, and registrant names. This allows the access unit to accurately evaluate registrability and trademark infringement risks by accessing databases of various countries.

The system comprises a listing unit that lists necessary documents and procedural steps. The listing unit lists necessary documents and procedural steps. Necessary documents include, for example, application forms, certificates, and contracts, but are not limited to these examples. Procedural steps include, for example, application procedures, examination procedures, and registration procedures, but are not limited to these examples. The listing unit lists the documents required for registration and trademark registration and provides them to the user. Additionally, the listing unit can list procedural steps and provide them to the user. For example, the listing unit lists the documents required for registration and trademark registration and provides them to the user. Necessary documents include, for example, application forms, certificates, and contracts. Procedural steps include, for example, application procedures, examination procedures, and registration procedures. This allows the listing unit to list necessary documents and procedural steps, streamlining procedures.

The analysis unit can optimize evaluation criteria by referring to past successful and unsuccessful cases during name analysis. The analysis unit optimizes evaluation criteria by referring to past successful and unsuccessful cases during name analysis. Past successful and unsuccessful cases include, for example, case databases and case studies, but are not limited to these examples. The analysis unit uses generative AI to analyze past successful and unsuccessful cases and optimize evaluation criteria. For example, generative AI analyzes the characteristics of names that have been successful in the past and highly evaluates names with similar characteristics. Additionally, generative AI analyzes the characteristics of names that have failed in the past and can evaluate names with similar characteristics lower. Furthermore, generative AI can dynamically adjust evaluation criteria by referring to databases of successful and unsuccessful cases. For example, generative AI refers to databases of past successful and unsuccessful cases to optimize evaluation criteria. This allows the analysis unit to optimize evaluation criteria by referring to past cases.

The analysis unit can apply evaluation algorithms specialized for specific industries or markets during name analysis. The analysis unit applies evaluation algorithms specialized for specific industries or markets during name analysis. Specific industries or markets include, for example, the IT industry, fashion market, and food industry, but are not limited to these examples. The analysis unit uses generative AI to apply evaluation algorithms specialized for specific industries or markets. For example, generative AI applies algorithms that emphasize technical images when analyzing names for the IT industry. Additionally, generative AI can apply algorithms that emphasize trends and styles when analyzing names for the fashion industry. Furthermore, generative AI can apply algorithms that emphasize taste and health when analyzing names for the food industry. For example, generative AI applies algorithms that emphasize technical images when analyzing names for the IT industry. Technical images include, for example, innovation, advancement, and reliability. When analyzing names for the fashion industry, generative AI applies algorithms that emphasize trends and styles. Trends and styles include, for example, the latest fashion trends, design beauty, and brand image. When analyzing names for the food industry, generative AI applies algorithms that emphasize taste and health. Taste and health include, for example, good taste, high nutritional value, and health orientation. This allows the analysis unit to apply evaluation algorithms specialized for specific industries or markets, providing more appropriate name candidates.

The analysis unit can evaluate regional-specific meanings and images based on the user's geographical location information during name analysis. The analysis unit evaluates regional-specific meanings and images based on the user's geographical location information during name analysis. Geographical location information includes, for example, GPS data, regional-specific culture, and customs, but is not limited to these examples. The analysis unit uses generative AI to evaluate regional-specific meanings and images by considering the user's geographical location information. For example, if the user is in Japan, generative AI emphasizes Japanese meanings and images when evaluating names. Additionally, if the user is in the United States, generative AI emphasizes English meanings and images when evaluating names. Furthermore, if the user is in France, generative AI emphasizes French meanings and images when evaluating names. For example, if the user is in Japan, generative AI emphasizes Japanese meanings and images when evaluating names. Japanese meanings and images include, for example, cultural compatibility, ease of pronunciation, and appropriateness of meaning. English meanings and images include, for example, ease of pronunciation, appropriateness of meaning, and cultural compatibility. French meanings and images include, for example, ease of pronunciation, appropriateness of meaning, and cultural compatibility. This allows the analysis unit to evaluate regional-specific meanings and images by considering the user's geographical location information.

The analysis unit can analyze the user's social media activities and propose related name candidates during name analysis. The analysis unit analyzes the user's social media activities and proposes related name candidates during name analysis. Social media activities include, for example, post content, follower count, and engagement rate, but are not limited to these examples. The analysis unit uses generative AI to analyze the user's social media activities and propose related name candidates. For example, generative AI analyzes hashtags frequently used by the user and proposes related name candidates. Additionally, generative AI can analyze the content of accounts followed by the user and propose related name candidates. Furthermore, generative AI can analyze the user's post content and propose related name candidates. For example, generative AI analyzes hashtags frequently used by the user and proposes related name candidates. Hashtags include, for example, keywords related to specific themes or topics. The content of accounts followed by the user includes, for example, fields or topics of interest to the user. Post content includes, for example, information or opinions that the user frequently shares. This allows the analysis unit to propose related name candidates by analyzing the user's social media activities.

The check unit can optimize evaluation criteria by referring to past precedents and legal data during the check of registrability and trademark infringement risk. The check unit optimizes evaluation criteria by referring to past precedents and legal data during the check of registrability and trademark infringement risk. Past precedents and legal data include, for example, precedent databases and legal documents, but are not limited to these examples. The check unit uses generative AI to analyze past precedents and legal data and optimize evaluation criteria. For example, generative AI refers to precedent databases to adjust evaluation criteria based on similar cases. Additionally, generative AI can refer to legal databases to optimize evaluation criteria based on the latest legal information. Furthermore, generative AI can analyze past trademark infringement cases to improve the accuracy of risk evaluation. For example, generative AI refers to precedent databases to adjust evaluation criteria based on similar cases. Precedent databases include detailed information and content of judgments. Legal databases include legal texts, interpretations, and legal guidelines. Past trademark infringement cases include information on trademark similarity and usage scope. This allows the check unit to optimize evaluation criteria by referring to past precedents and legal data.

The check unit can apply evaluation algorithms specialized for specific industries or markets during the check of registrability and trademark infringement risk. The check unit applies evaluation algorithms specialized for specific industries or markets during the check of registrability and trademark infringement risk. Specific industries or markets include, for example, the IT industry, fashion market, and food industry, but are not limited to these examples. The check unit uses generative AI to apply evaluation algorithms specialized for specific industries or markets. For example, generative AI applies algorithms that emphasize technical elements when checking names for the IT industry. Additionally, generative AI can apply algorithms that emphasize trends and styles when checking names for the fashion industry. Furthermore, generative AI can apply algorithms that emphasize taste and health when checking names for the food industry. For example, generative AI applies algorithms that emphasize technical elements when checking names for the IT industry. Technical elements include, for example, innovation, advancement, and reliability. When checking names for the fashion industry, generative AI applies algorithms that emphasize trends and styles. Trends and styles include, for example, the latest fashion trends, design beauty, and brand image. When checking names for the food industry, generative AI applies algorithms that emphasize taste and health. Taste and health include, for example, good taste, high nutritional value, and health orientation. This allows the check unit to apply evaluation algorithms specialized for specific industries or markets, enabling more appropriate risk evaluation.

The check unit can evaluate regional-specific risks by considering the user's geographical location information during the check of registrability and trademark infringement risk. The check unit evaluates regional-specific risks by considering the user's geographical location information during the check of registrability and trademark infringement risk. Geographical location information includes, for example, GPS data, regional-specific culture, and customs, but is not limited to these examples. The check unit uses generative AI to evaluate regional-specific risks by considering the user's geographical location information. For example, if the user is in Japan, generative AI prioritizes referring to Japanese trademark databases to evaluate risks. Additionally, if the user is in the United States, generative AI prioritizes referring to American trademark databases to evaluate risks. Furthermore, if the user is in France, generative AI prioritizes referring to French trademark databases to evaluate risks. For example, if the user is in Japan, generative AI prioritizes referring to Japanese trademark databases to evaluate risks. Japanese trademark databases include information such as trademark registration numbers, registration dates, and registrant names. American trademark databases include information such as trademark registration numbers, registration dates, and registrant names. French trademark databases include information such as trademark registration numbers, registration dates, and registrant names. This allows the check unit to evaluate regional-specific risks by considering the user's geographical location information.

The check unit can analyze the user's social media activities and propose related risks during the check of registrability and trademark infringement risk. The check unit analyzes the user's social media activities and proposes related risks during the check of registrability and trademark infringement risk. Social media activities include, for example, post content, follower count, and engagement rate, but are not limited to these examples. The check unit uses generative AI to analyze the user's social media activities and propose related risks. For example, generative AI analyzes hashtags frequently used by the user and proposes related risks. Additionally, generative AI can analyze the content of accounts followed by the user and propose related risks. Furthermore, generative AI can analyze the user's post content and propose related risks. For example, generative AI analyzes hashtags frequently used by the user and proposes related risks. Hashtags include, for example, keywords related to specific themes or topics. The content of accounts followed by the user includes, for example, fields or topics of interest to the user. Post content includes, for example, information or opinions that the user frequently shares. This allows the check unit to propose related risks by analyzing the user's social media activities.

The organization unit can select the optimal organization method by referring to past application data during the organization of application information. The organization unit selects the optimal organization method by referring to past application data during the organization of application information. Past application data includes, for example, application history databases and case studies, but is not limited to these examples. The organization unit uses generative AI to analyze past application data and select the optimal organization method. For example, generative AI refers to past successful application data and proposes similar organization methods. Additionally, generative AI can refer to past unsuccessful application data and propose organization methods that avoid similar mistakes. Furthermore, generative AI can dynamically select the optimal organization method by referring to past application databases. For example, generative AI refers to past successful application data and proposes similar organization methods. Application history databases include detailed information and results of applications. Case studies include analyses and evaluations based on specific cases. This allows the organization unit to select the optimal organization method by referring to past application data.

The organization unit can apply organization algorithms specialized for specific industries or markets during the organization of application information. The organization unit applies organization algorithms specialized for specific industries or markets during the organization of application information. Specific industries or markets include, for example, the IT industry, fashion market, and food industry, but are not limited to these examples. The organization unit uses generative AI to apply organization algorithms specialized for specific industries or markets. For example, generative AI applies algorithms that emphasize technical elements when organizing application information for the IT industry. Additionally, generative AI can apply algorithms that emphasize trends and styles when organizing application information for the fashion industry. Furthermore, generative AI can apply algorithms that emphasize taste and health when organizing application information for the food industry. For example, generative AI applies algorithms that emphasize technical elements when organizing application information for the IT industry. Technical elements include, for example, innovation, advancement, and reliability. When organizing application information for the fashion industry, generative AI applies algorithms that emphasize trends and styles. Trends and styles include, for example, the latest fashion trends, design beauty, and brand image. When organizing application information for the food industry, generative AI applies algorithms that emphasize taste and health. Taste and health include, for example, good taste, high nutritional value, and health orientation. This allows the organization unit to apply organization algorithms specialized for specific industries or markets, enabling more appropriate organization of application information.

The organization unit can organize regional-specific information by considering the user's geographical location information during the organization of application information. The organization unit organizes regional-specific information by considering the user's geographical location information during the organization of application information. Geographical location information includes, for example, GPS data, regional-specific culture, and customs, but is not limited to these examples. The organization unit uses generative AI to organize regional-specific information by considering the user's geographical location information. For example, if the user is in Japan, generative AI organizes application information based on Japanese legal requirements. Additionally, if the user is in the United States, generative AI organizes application information based on American legal requirements. Furthermore, if the user is in France, generative AI organizes application information based on French legal requirements. For example, if the user is in Japan, generative AI organizes application information based on Japanese legal requirements. Japanese legal requirements include, for example, trademark registration procedures and necessary documents. American legal requirements include, for example, trademark registration procedures and necessary documents. French legal requirements include, for example, trademark registration procedures and necessary documents. This allows the organization unit to organize regional-specific information by considering the user's geographical location information.

The organization unit can analyze the user's social media activities and organize related information during the organization of application information. The organization unit analyzes the user's social media activities and organizes related information during the organization of application information. Social media activities include, for example, post content, follower count, and engagement rate, but are not limited to these examples. The organization unit uses generative AI to analyze the user's social media activities and organize related information. For example, generative AI analyzes hashtags frequently used by the user and organizes related application information. Additionally, generative AI can analyze the content of accounts followed by the user and organize related application information. Furthermore, generative AI can analyze the user's post content and organize related application information. For example, generative AI analyzes hashtags frequently used by the user and organizes related application information. Hashtags include, for example, keywords related to specific themes or topics. The content of accounts followed by the user includes, for example, fields or topics of interest to the user. Post content includes, for example, information or opinions that the user frequently shares. This allows the organization unit to organize related information by analyzing the user's social media activities.

The collection unit can select the optimal collection method by referring to past data during the collection of market research data. The collection unit selects the optimal collection method by referring to past data during the collection of market research data. Past data includes, for example, databases and case studies, but is not limited to these examples. The collection unit uses generative AI to analyze past data and select the optimal collection method. For example, generative AI refers to past successful market research data and proposes similar collection methods. Additionally, generative AI can refer to past unsuccessful market research data and propose collection methods that avoid similar mistakes. Furthermore, generative AI can dynamically select the optimal collection method by referring to past market research databases. For example, generative AI refers to past successful market research data and proposes similar collection methods. Databases include past market research data and analysis results. Case studies include analyses and evaluations based on specific cases. This allows the collection unit to select the optimal collection method by referring to past data.

The collection unit can apply collection algorithms specialized for specific industries or markets during the collection of market research data. The collection unit applies collection algorithms specialized for specific industries or markets during the collection of market research data. Specific industries or markets include, for example, the IT industry, fashion market, and food industry, but are not limited to these examples. The collection unit uses generative AI to apply collection algorithms specialized for specific industries or markets. For example, generative AI applies algorithms that emphasize technical elements when collecting market research data for the IT industry. Additionally, generative AI can apply algorithms that emphasize trends and styles when collecting market research data for the fashion industry. Furthermore, generative AI can apply algorithms that emphasize taste and health when collecting market research data for the food industry. For example, generative AI applies algorithms that emphasize technical elements when collecting market research data for the IT industry. Technical elements include, for example, innovation, advancement, and reliability. When collecting market research data for the fashion industry, generative AI applies algorithms that emphasize trends and styles. Trends and styles include, for example, the latest fashion trends, design beauty, and brand image. When collecting market research data for the food industry, generative AI applies algorithms that emphasize taste and health. Taste and health include, for example, good taste, high nutritional value, and health orientation. This allows the collection unit to apply collection algorithms specialized for specific industries or markets, enabling more appropriate data collection.

The collection unit can prioritize the collection of highly relevant data by considering the user's geographical location information during the collection of market research data. The collection unit prioritizes the collection of highly relevant data by considering the user's geographical location information during the collection of market research data. Geographical location information includes, for example, GPS data, regional-specific culture, and customs, but is not limited to these examples. The collection unit uses generative AI to prioritize the collection of highly relevant data by considering the user's geographical location information. For example, if the user is in Japan, generative AI prioritizes collecting Japanese market data. Additionally, if the user is in the United States, generative AI prioritizes collecting American market data. Furthermore, if the user is in France, generative AI prioritizes collecting French market data. For example, if the user is in Japan, generative AI prioritizes collecting Japanese market data. Japanese market data includes information such as consumer preferences and purchasing behavior. American market data includes information such as consumer preferences and purchasing behavior. French market data includes information such as consumer preferences and purchasing behavior. This allows the collection unit to prioritize the collection of highly relevant data by considering the user's geographical location information.

The collection unit can analyze the user's social media activities and prioritize the collection of related data during the collection of market research data. The collection unit analyzes the user's social media activities and prioritizes the collection of related data during the collection of market research data. Social media activities include, for example, post content, follower count, and engagement rate, but are not limited to these examples. The collection unit uses generative AI to analyze the user's social media activities and prioritize the collection of related data. For example, generative AI analyzes hashtags frequently used by the user and prioritizes collecting related market data. Additionally, generative AI can analyze the content of accounts followed by the user and prioritize collecting related market data. Furthermore, generative AI can analyze the user's post content and prioritize collecting related market data. For example, generative AI analyzes hashtags frequently used by the user and prioritizes collecting related market data. Hashtags include, for example, keywords related to specific themes or topics. The content of accounts followed by the user includes, for example, fields or topics of interest to the user. Post content includes, for example, information or opinions that the user frequently shares. This allows the collection unit to prioritize the collection of related data by analyzing the user's social media activities.

The access unit can select the optimal access method by referring to past access history during database access. The access unit selects the optimal access method by referring to past access history during database access. Past access history includes, for example, access logs and case studies, but is not limited to these examples. The access unit uses generative AI to analyze past access history and select the optimal access method. For example, generative AI refers to past successful access history and proposes similar access methods. Additionally, generative AI can refer to past unsuccessful access history and propose access methods that avoid similar mistakes. Furthermore, generative AI can dynamically select the optimal access method by referring to past access history databases. For example, generative AI refers to past successful access history and proposes similar access methods. Access logs include detailed information and results of past accesses. Case studies include analyses and evaluations based on specific cases. This allows the access unit to select the optimal access method by referring to past access history.

The access unit can apply access algorithms specialized for specific industries or markets during database access. The access unit applies access algorithms specialized for specific industries or markets during database access. Specific industries or markets include, for example, the IT industry, fashion market, and food industry, but are not limited to these examples. The access unit uses generative AI to apply access algorithms specialized for specific industries or markets. For example, generative AI applies algorithms that emphasize technical elements when accessing databases for the IT industry. Additionally, generative AI can apply algorithms that emphasize trends and styles when accessing databases for the fashion industry. Furthermore, generative AI can apply algorithms that emphasize taste and health when accessing databases for the food industry. For example, generative AI applies algorithms that emphasize technical elements when accessing databases for the IT industry. Technical elements include, for example, innovation, advancement, and reliability. When accessing databases for the fashion industry, generative AI applies algorithms that emphasize trends and styles. Trends and styles include, for example, the latest fashion trends, design beauty, and brand image. When accessing databases for the food industry, generative AI applies algorithms that emphasize taste and health. Taste and health include, for example, good taste, high nutritional value, and health orientation. This allows the access unit to apply access algorithms specialized for specific industries or markets, enabling more appropriate database access.

The access unit can prioritize access to highly relevant databases by considering the user's geographical location information during database access. The access unit prioritizes access to highly relevant databases by considering the user's geographical location information during database access. Geographical location information includes, for example, GPS data, regional-specific culture, and customs, but is not limited to these examples. The access unit uses generative AI to prioritize access to highly relevant databases by considering the user's geographical location information. For example, if the user is in Japan, generative AI prioritizes accessing Japanese databases. Additionally, if the user is in the United States, generative AI prioritizes accessing American databases. Furthermore, if the user is in France, generative AI prioritizes accessing French databases. For example, if the user is in Japan, generative AI prioritizes accessing Japanese databases. Japanese databases include information such as trademark registration and registration information. American databases include information such as trademark registration and registration information. French databases include information such as trademark registration and registration information. This allows the access unit to prioritize access to highly relevant databases by considering the user's geographical location information.

The access unit can analyze the user's social media activities and prioritize access to related databases during database access. The access unit analyzes the user's social media activities and prioritizes access to related databases during database access. Social media activities include, for example, post content, follower count, and engagement rate, but are not limited to these examples. The access unit uses generative AI to analyze the user's social media activities and prioritize access to related databases. For example, generative AI analyzes hashtags frequently used by the user and prioritizes access to related databases. Additionally, generative AI can analyze the content of accounts followed by the user and prioritize access to related databases. Furthermore, generative AI can analyze the user's post content and prioritize access to related databases. For example, generative AI analyzes hashtags frequently used by the user and prioritizes access to related databases. Hashtags include, for example, keywords related to specific themes or topics. The content of accounts followed by the user includes, for example, fields or topics of interest to the user. Post content includes, for example, information or opinions that the user frequently shares. This allows the access unit to prioritize access to related databases by analyzing the user's social media activities.

The listing unit can select the optimal listing method by referring to past listing data during listing. The listing unit selects the optimal listing method by referring to past listing data during listing. Past listing data includes, for example, databases and case studies, but is not limited to these examples. The listing unit uses generative AI to analyze past listing data and select the optimal listing method. For example, generative AI refers to past successful listing data and proposes similar listing methods. Additionally, generative AI can refer to past unsuccessful listing data and propose listing methods that avoid similar mistakes. Furthermore, generative AI can dynamically select the optimal listing method by referring to past listing databases. For example, generative AI refers to past successful listing data and proposes similar listing methods. Databases include past listing data and analysis results. Case studies include analyses and evaluations based on specific cases. This allows the listing unit to select the optimal listing method by referring to past listing data.

The listing unit can apply listing algorithms specialized for specific industries or markets during listing. The listing unit applies listing algorithms specialized for specific industries or markets during listing. Specific industries or markets include, for example, the IT industry, fashion market, and food industry, but are not limited to these examples. The listing unit uses generative AI to apply listing algorithms specialized for specific industries or markets. For example, generative AI applies algorithms that emphasize technical elements when listing for the IT industry. Additionally, generative AI can apply algorithms that emphasize trends and styles when listing for the fashion industry. Furthermore, generative AI can apply algorithms that emphasize taste and health when listing for the food industry. For example, generative AI applies algorithms that emphasize technical elements when listing for the IT industry. Technical elements include, for example, innovation, advancement, and reliability. When listing for the fashion industry, generative AI applies algorithms that emphasize trends and styles. Trends and styles include, for example, the latest fashion trends, design beauty, and brand image. When listing for the food industry, generative AI applies algorithms that emphasize taste and health. Taste and health include, for example, good taste, high nutritional value, and health orientation. This allows the listing unit to apply listing algorithms specialized for specific industries or markets, enabling more appropriate listing.

The listing unit can prioritize the listing of highly relevant items by considering the user's geographical location information during listing. The listing unit prioritizes the listing of highly relevant items by considering the user's geographical location information during listing. Geographical location information includes, for example, GPS data, regional-specific culture, and customs, but is not limited to these examples. The listing unit uses generative AI to prioritize the listing of highly relevant items by considering the user's geographical location information. For example, if the user is in Japan, generative AI lists items based on Japanese legal requirements. Additionally, if the user is in the United States, generative AI lists items based on American legal requirements. Furthermore, if the user is in France, generative AI lists items based on French legal requirements. For example, if the user is in Japan, generative AI lists items based on Japanese legal requirements. Japanese legal requirements include, for example, trademark registration procedures and necessary documents. American legal requirements include, for example, trademark registration procedures and necessary documents. French legal requirements include, for example, trademark registration procedures and necessary documents. This allows the listing unit to prioritize the listing of highly relevant items by considering the user's geographical location information.

The listing unit can analyze the user's social media activities and prioritize the listing of related items during listing. The listing unit analyzes the user's social media activities and prioritizes the listing of related items during listing. Social media activities include, for example, post content, follower count, and engagement rate, but are not limited to these examples. The listing unit uses generative AI to analyze the user's social media activities and prioritize the listing of related items. For example, generative AI analyzes hashtags frequently used by the user and prioritizes the listing of related items. Additionally, generative AI can analyze the content of accounts followed by the user and prioritize the listing of related items. Furthermore, generative AI can analyze the user's post content and prioritize the listing of related items. For example, generative AI analyzes hashtags frequently used by the user and prioritizes the listing of related items. Hashtags include, for example, keywords related to specific themes or topics. The content of accounts followed by the user includes, for example, fields or topics of interest to the user. Post content includes, for example, information or opinions that the user frequently shares. This allows the listing unit to prioritize the listing of related items by analyzing the user's social media activities.

The system according to the embodiment is not limited to the examples described above and can be modified in various ways, such as the following.

The analysis unit can also evaluate the phonetic characteristics of names during the analysis of name appropriateness. For example, it evaluates how the sound and rhythm of names are perceived in specific cultures or languages. This allows the determination of whether names are easy to pronounce and remember. Additionally, the analysis unit can use speech recognition technology to evaluate the phonetic characteristics of names. For example, it analyzes the pronunciation of names using speech recognition technology to evaluate the difficulty of pronunciation. Furthermore, the analysis unit can refer to phonetic databases to evaluate the phonetic characteristics of names. For example, phonetic databases include phonetic patterns and pronunciation rules of various languages. This allows the analysis unit to evaluate the phonetic characteristics of names, providing more appropriate name candidates.

The collection unit can also collect data in real-time during the collection of market research data. For example, it collects social media trends and news articles in real-time and uses them as data to evaluate the appropriateness of names. Additionally, the collection unit can provide real-time collected data to the analysis unit to dynamically adjust name evaluation criteria. Furthermore, the collection unit can provide real-time collected data to users and propose name candidates that reflect the latest market trends. For example, the collection unit collects social media trends in real-time and proposes name candidates. This allows the collection unit to provide more appropriate name candidates by collecting data in real-time.

The access unit can also consider the update frequency of databases when accessing trademark databases and registration databases of various countries. For example, if databases are frequently updated, it increases the access frequency to obtain the latest information. Additionally, the access unit can dynamically adjust the access schedule based on the update frequency of databases. Furthermore, the access unit can provide the latest information to users based on the update frequency of databases. For example, if databases are updated daily, the access unit accesses them daily to obtain the latest information. This allows the access unit to provide more accurate information by considering the update frequency of databases.

The listing unit can also refer to the user's past procedural history when listing necessary documents and procedural steps. For example, it automatically lists similar procedures if the user has previously conducted similar procedures. Additionally, the listing unit can optimize procedural steps based on the user's past procedural history. Furthermore, the listing unit can automatically generate necessary documents by referring to the user's past procedural history. For example, the listing unit refers to the user's past procedural history and automatically generates necessary documents. This allows the listing unit to streamline procedures by referring to the user's past procedural history.

The analysis unit can optimize evaluation criteria by referring to past successful and unsuccessful cases during name analysis. For example, generative AI analyzes the characteristics of names that have been successful in the past and highly evaluates names with similar characteristics. Additionally, generative AI analyzes the characteristics of names that have failed in the past and can evaluate names with similar characteristics lower. Furthermore, generative AI can dynamically adjust evaluation criteria by referring to databases of successful and unsuccessful cases. This allows the analysis unit to optimize evaluation criteria by referring to past cases.

The analysis unit can apply evaluation algorithms specialized for specific industries or markets during name analysis. For example, generative AI applies algorithms that emphasize technical images when analyzing names for the IT industry. Additionally, generative AI can apply algorithms that emphasize trends and styles when analyzing names for the fashion industry. Furthermore, generative AI can apply algorithms that emphasize taste and health when analyzing names for the food industry. This allows the analysis unit to apply evaluation algorithms specialized for specific industries or markets, providing more appropriate name candidates.

The analysis unit can evaluate regional-specific meanings and images based on the user's geographical location information during name analysis. For example, generative AI emphasizes Japanese meanings and images when evaluating names if the user is in Japan. Additionally, generative AI can emphasize English meanings and images when evaluating names if the user is in the United States. Furthermore, generative AI can emphasize French meanings and images when evaluating names if the user is in France. This allows the analysis unit to evaluate regional-specific meanings and images by considering the user's geographical location information.

The analysis unit can analyze the user's social media activities and propose related name candidates during name analysis. For example, generative AI analyzes hashtags frequently used by the user and proposes related name candidates. Additionally, generative AI can analyze the content of accounts followed by the user and propose related name candidates. Furthermore, generative AI can analyze the user's post content and propose related name candidates. This allows the analysis unit to propose related name candidates by analyzing the user's social media activities.

The following briefly explains the process flow of Example 1 of the Embodiment.

Step 1: The analysis unit analyzes the appropriateness of names. The appropriateness of names includes cultural compatibility, ease of pronunciation, and appropriateness of meaning. The analysis unit uses generative AI to analyze the meaning and image of names and further evaluates them by referring to market research data and databases of various countries.

Step 2: The check unit checks the registrability in various countries and the risk of trademark infringement based on name candidates generated by the analysis unit. The check unit accesses trademark databases and registration databases of various countries through related APIs to confirm whether the input name is already registered or poses a risk of trademark infringement.

Step 3: The organization unit organizes application information for registration and trademark registration based on the results obtained by the check unit. The organization unit lists necessary documents and procedural steps and provides them to the user.

### Example 2 of the Embodiment

The system according to the embodiment is a system that streamlines the consideration and implementation of company names and service names during entrepreneurship, new service development, and new business consideration. This system is composed of the following steps by linking generative AI with related APIs (market research and databases of various countries). First, the user inputs the company name or service name under consideration. Next, the generative AI analyzes the appropriateness of the name (such as its meaning and image) and lists appropriate candidates. During this process, the generative AI refers to market research data and databases of various countries to evaluate the meaning and image of the name. Then, the generative AI checks the registrability in various countries and the risk of trademark infringement. Specifically, it accesses trademark databases and registration databases of various countries through related APIs to confirm whether the input name is already registered or poses a risk of trademark infringement. This result is also listed and provided to the user. Furthermore, the generative AI organizes application information for registration and trademark registration and provides it to the user. This allows the user to proceed with procedures efficiently. For example, by automatically listing necessary documents and procedural steps and providing them to the user, the system aims to streamline procedures. This system contributes to the efficiency of considering and implementing company names and service names during entrepreneurship, new service development, and new business consideration, thereby enhancing the efficiency of planning and procedures. As a result, the system can streamline the consideration and implementation of company names and service names during entrepreneurship, new service development, and new business consideration.

The system according to the embodiment comprises an analysis unit, a check unit, and an organization unit. The analysis unit analyzes the appropriateness of names. The appropriateness of names includes, for example, cultural compatibility, ease of pronunciation, and appropriateness of meaning, but is not limited to these examples. The analysis unit uses generative AI to analyze the meaning and image of names. Generative AI, for example, uses text-generating AI (such as LLM) to evaluate the meaning and image of names. Additionally, the analysis unit can evaluate the appropriateness of names by referring to market research data and databases of various countries using generative AI. For example, generative AI collects relevant market research data and evaluates the meaning and image of names. The check unit checks the registrability in various countries and the risk of trademark infringement based on name candidates generated by the analysis unit. The check unit accesses trademark databases and registration databases of various countries through related APIs to confirm whether the input name is already registered or poses a risk of trademark infringement. For example, the check unit accesses trademark databases of various countries to confirm whether the name is already registered. Additionally, the check unit can access registration databases of various countries to confirm whether the name is registrable. The organization unit organizes application information for registration and trademark registration based on the results obtained by the check unit. The organization unit lists necessary documents and procedural steps and provides them to the user. For example, the organization unit lists the documents required for registration and trademark registration and provides them to the user. Additionally, the organization unit can list procedural steps and provide them to the user. This allows the system according to the embodiment to efficiently check the appropriateness of names, registrability, and trademark infringement risks, and organize application information, enabling efficient consideration and implementation of names.

The analysis unit analyzes the appropriateness of names. The appropriateness of names includes, for example, cultural compatibility, ease of pronunciation, and appropriateness of meaning, but is not limited to these examples. The analysis unit uses generative AI to analyze the meaning and image of names. Generative AI, for example, uses text-generating AI (such as LLM) to evaluate the meaning and image of names. Specifically, generative AI learns from a large amount of text data to analyze the cultural background and historical meaning of names. For example, it can evaluate how a specific name is perceived in a particular culture or region and assess the positive or negative image associated with that name. Furthermore, generative AI can use speech recognition technology to evaluate the ease of pronunciation of names. This allows the analysis of how names are pronounced in different languages and accents, evaluating the ease of pronunciation. Additionally, generative AI can analyze the meaning and related words of names to evaluate the appropriateness of names in specific contexts. For example, it can evaluate how a name is perceived in a particular industry or market. Furthermore, the analysis unit can evaluate the appropriateness of names by referring to market research data and databases of various countries using generative AI. For example, generative AI collects relevant market research data and evaluates the meaning and image of names. This allows the analysis unit to evaluate the appropriateness of names from multiple perspectives and provide optimal name candidates to the user.

The check unit checks the registrability in various countries and the risk of trademark infringement based on name candidates generated by the analysis unit. The check unit accesses trademark databases and registration databases of various countries through related APIs to confirm whether the input name is already registered or poses a risk of trademark infringement. Specifically, the check unit accesses trademark databases of various countries to confirm whether the name is already registered. Additionally, the check unit can access registration databases of various countries to confirm whether the name is registrable. For example, if a specific name is already registered as a trademark, the check unit confirms whether using that name poses legal issues. Additionally, the check unit confirms whether the name is registrable in specific countries or regions and provides the results to the user. Furthermore, the check unit evaluates the risk of trademark infringement by analyzing the degree of similarity between the name and existing trademarks. This allows the evaluation of the risk of confusion with existing trademarks, providing appropriate advice to the user. For example, if the name is similar in sound or spelling to existing trademarks, the check unit evaluates the risk and can propose alternatives to the user. This allows the check unit to quickly and accurately evaluate the registrability and trademark infringement risk of names, providing information to minimize legal risks for the user.

The organization unit organizes application information for registration and trademark registration based on the results obtained by the check unit. The organization unit lists necessary documents and procedural steps and provides them to the user. Specifically, the organization unit lists the documents required for registration and trademark registration and provides them to the user. Additionally, the organization unit can list procedural steps and provide them to the user. For example, the organization unit lists the documents and procedures required for registration and trademark registration in specific countries or regions and provides them to the user in an easy-to-understand manner. This allows the user to prepare the necessary documents without omission and proceed with procedures smoothly. Furthermore, the organization unit can provide document formats and examples to support the user in accurately creating documents. For example, the organization unit provides templates for registration and trademark registration application documents, allowing the user to accurately fill in the necessary information. Additionally, the organization unit can track the progress of procedures and provide timely notifications to the user. This allows the user to grasp the progress of procedures and respond promptly as needed. Furthermore, the organization unit can check and correct the documents submitted by the user to support smooth application processing. This allows the organization unit to support the user in efficiently carrying out registration and trademark registration procedures, increasing the success rate of procedures.

The system comprises a collection unit that collects market research data. The collection unit collects market research data. Market research data includes, for example, consumer surveys, sales data, and competitive analysis, but is not limited to these examples. The collection unit conducts consumer surveys and collects consumer opinions. Additionally, the collection unit collects sales data and analyzes product sales performance. Furthermore, the collection unit conducts competitive analysis to understand the trends of competitors. For example, the collection unit conducts consumer surveys to collect consumer opinions. Consumer surveys are conducted using methods such as online surveys and telephone interviews. Sales data is collected from sources such as POS data and online sales data. Competitive analysis involves collecting and analyzing information from sources such as competitor websites and market reports. This allows the collection unit to collect market research data to more accurately evaluate the appropriateness of names.

The system comprises an access unit that accesses trademark databases and registration databases of various countries. The access unit accesses trademark databases and registration databases of various countries. Trademark databases include, for example, databases of trademark registration agencies in various countries, but are not limited to these examples. Registration databases include, for example, databases of registration agencies in various countries, but are not limited to these examples. The access unit accesses databases of trademark registration agencies in various countries to confirm whether the name is already registered. Additionally, the access unit can access databases of registration agencies in various countries to confirm whether the name is registrable. For example, the access unit accesses databases of trademark registration agencies in various countries to confirm whether the name is already registered. Trademark databases include information such as trademark registration numbers, registration dates, and registrant names. Registration databases include information such as registration numbers, registration dates, and registrant names. This allows the access unit to accurately evaluate registrability and trademark infringement risks by accessing databases of various countries.

The system comprises a listing unit that lists necessary documents and procedural steps. The listing unit lists necessary documents and procedural steps. Necessary documents include, for example, application forms, certificates, and contracts, but are not limited to these examples. Procedural steps include, for example, application procedures, examination procedures, and registration procedures, but are not limited to these examples. The listing unit lists the documents required for registration and trademark registration and provides them to the user. Additionally, the listing unit can list procedural steps and provide them to the user. For example, the listing unit lists the documents required for registration and trademark registration and provides them to the user. Necessary documents include, for example, application forms, certificates, and contracts. Procedural steps include, for example, application procedures, examination procedures, and registration procedures. This allows the listing unit to list necessary documents and procedural steps, streamlining procedures.

The analysis unit can estimate the user's emotions and adjust the evaluation criteria for name candidates based on the estimated emotions. The analysis unit estimates the user's emotions and adjusts the evaluation criteria for name candidates based on the estimated emotions. User emotions include, for example, excitement, anxiety, and relaxation, but are not limited to these examples. The analysis unit uses facial recognition technology to estimate the user's emotions. For example, the analysis unit captures the user's facial expressions with a camera and uses facial recognition algorithms to estimate emotions. Additionally, the analysis unit can use voice analysis technology to estimate the user's emotions. For example, the analysis unit analyzes the tone and speed of the user's voice to estimate emotions. Furthermore, the analysis unit can use survey results to estimate the user's emotions. For example, the analysis unit conducts surveys with users to evaluate emotions. This allows the analysis unit to adjust the evaluation criteria for names based on the user's emotions, providing more appropriate name candidates. Emotion estimation is realized using emotion engines or generative AI, such as text-generating AI (e.g., LLM) or multimodal generative AI, but is not limited to these examples. For example, if the user is excited, the generative AI prioritizes names with positive meanings and images. Additionally, if the user feels anxious, the generative AI prioritizes names that provide a sense of security. Furthermore, if the user is relaxed, the generative AI prioritizes names with a soft sound. This allows the analysis unit to adjust the evaluation criteria for names based on the user's emotions, providing more appropriate name candidates.

The analysis unit can optimize evaluation criteria by referring to past successful and unsuccessful cases during name analysis. The analysis unit optimizes evaluation criteria by referring to past successful and unsuccessful cases during name analysis. Past successful and unsuccessful cases include, for example, case databases and case studies, but are not limited to these examples. The analysis unit uses generative AI to analyze past successful and unsuccessful cases and optimize evaluation criteria. For example, generative AI analyzes the characteristics of names that have been successful in the past and highly evaluates names with similar characteristics. Additionally, generative AI analyzes the characteristics of names that have failed in the past and can evaluate names with similar characteristics lower. Furthermore, generative AI can dynamically adjust evaluation criteria by referring to databases of successful and unsuccessful cases. For example, generative AI refers to databases of past successful and unsuccessful cases to optimize evaluation criteria. This allows the analysis unit to optimize evaluation criteria by referring to past cases.

The analysis unit can apply evaluation algorithms specialized for specific industries or markets during name analysis. The analysis unit applies evaluation algorithms specialized for specific industries or markets during name analysis. Specific industries or markets include, for example, the IT industry, fashion market, and food industry, but are not limited to these examples. The analysis unit uses generative AI to apply evaluation algorithms specialized for specific industries or markets. For example, generative AI applies algorithms that emphasize technical images when analyzing names for the IT industry. Additionally, generative AI can apply algorithms that emphasize trends and styles when analyzing names for the fashion industry. Furthermore, generative AI can apply algorithms that emphasize taste and health when analyzing names for the food industry. For example, generative AI applies algorithms that emphasize technical images when analyzing names for the IT industry. Technical images include, for example, innovation, advancement, and reliability. When analyzing names for the fashion industry, generative AI applies algorithms that emphasize trends and styles. Trends and styles include, for example, the latest fashion trends, design beauty, and brand image. When analyzing names for the food industry, generative AI applies algorithms that emphasize taste and health. Taste and health include, for example, good taste, high nutritional value, and health orientation. This allows the analysis unit to apply evaluation algorithms specialized for specific industries or markets, providing more appropriate name candidates.

The analysis unit can estimate the user's emotions and determine the priority of name candidates based on the estimated emotions. The analysis unit estimates the user's emotions and determines the priority of name candidates based on the estimated emotions. User emotions include, for example, excitement, anxiety, and relaxation, but are not limited to these examples. The analysis unit uses facial recognition technology to estimate the user's emotions. For example, the analysis unit captures the user's facial expressions with a camera and uses facial recognition algorithms to estimate emotions. Additionally, the analysis unit can use voice analysis technology to estimate the user's emotions. For example, the analysis unit analyzes the tone and speed of the user's voice to estimate emotions. Furthermore, the analysis unit can use survey results to estimate the user's emotions. For example, the analysis unit conducts surveys with users to evaluate emotions. This allows the analysis unit to determine the priority of name candidates based on the user's emotions, providing more appropriate name candidates. Emotion estimation is realized using emotion engines or generative AI, such as text-generating AI (e.g., LLM) or multimodal generative AI, but is not limited to these examples. For example, if the user is excited, the generative AI prioritizes names with positive meanings and images at the top of the list. Additionally, if the user feels anxious, the generative AI prioritizes names that provide a sense of security at the top of the list. Furthermore, if the user is relaxed, the generative AI prioritizes names with a soft sound at the top of the list. This allows the analysis unit to determine the priority of name candidates based on the user's emotions, providing more appropriate name candidates.

The analysis unit can evaluate regional-specific meanings and images based on the user's geographical location information during name analysis. The analysis unit evaluates regional-specific meanings and images based on the user's geographical location information during name analysis. Geographical location information includes, for example, GPS data, regional-specific culture, and customs, but is not limited to these examples. The analysis unit uses generative AI to evaluate regional-specific meanings and images by considering the user's geographical location information. For example, if the user is in Japan, generative AI emphasizes Japanese meanings and images when evaluating names. Additionally, if the user is in the United States, generative AI emphasizes English meanings and images when evaluating names. Furthermore, if the user is in France, generative AI emphasizes French meanings and images when evaluating names. For example, if the user is in Japan, generative AI emphasizes Japanese meanings and images when evaluating names. Japanese meanings and images include, for example, cultural compatibility, ease of pronunciation, and appropriateness of meaning. English meanings and images include, for example, ease of pronunciation, appropriateness of meaning, and cultural compatibility. French meanings and images include, for example, ease of pronunciation, appropriateness of meaning, and cultural compatibility. This allows the analysis unit to evaluate regional-specific meanings and images by considering the user's geographical location information.

The analysis unit can analyze the user's social media activities and propose related name candidates during name analysis. The analysis unit analyzes the user's social media activities and proposes related name candidates during name analysis. Social media activities include, for example, post content, follower count, and engagement rate, but are not limited to these examples. The analysis unit uses generative AI to analyze the user's social media activities and propose related name candidates. For example, generative AI analyzes hashtags frequently used by the user and proposes related name candidates. Additionally, generative AI can analyze the content of accounts followed by the user and propose related name candidates. Furthermore, generative AI can analyze the user's post content and propose related name candidates. For example, generative AI analyzes hashtags frequently used by the user and proposes related name candidates. Hashtags include, for example, keywords related to specific themes or topics. The content of accounts followed by the user includes, for example, fields or topics of interest to the user. Post content includes, for example, information or opinions that the user frequently shares. This allows the analysis unit to propose related name candidates by analyzing the user's social media activities.

The check unit can estimate the user's emotions and adjust the evaluation criteria for registrability and trademark infringement risk based on the estimated emotions. The check unit estimates the user's emotions and adjusts the evaluation criteria for registrability and trademark infringement risk based on the estimated emotions. User emotions include, for example, excitement, anxiety, and relaxation, but are not limited to these examples. The check unit uses facial recognition technology to estimate the user's emotions. For example, the check unit captures the user's facial expressions with a camera and uses facial recognition algorithms to estimate emotions. Additionally, the check unit can use voice analysis technology to estimate the user's emotions. For example, the check unit analyzes the tone and speed of the user's voice to estimate emotions. Furthermore, the check unit can use survey results to estimate the user's emotions. For example, the check unit conducts surveys with users to evaluate emotions. This allows the check unit to adjust the evaluation criteria for registrability and trademark infringement risk based on the user's emotions, enabling more appropriate risk evaluation. Emotion estimation is realized using emotion engines or generative AI, such as text-generating AI (e.g., LLM) or multimodal generative AI, but is not limited to these examples. For example, if the user is excited, the generative AI adjusts the tendency to underestimate risks and conducts careful evaluation. Additionally, if the user feels anxious, the generative AI adjusts the tendency to overestimate risks and conducts evaluations that provide a sense of security. Furthermore, if the user is relaxed, the generative AI can conduct balanced evaluations. This allows the check unit to adjust evaluation criteria based on the user's emotions, enabling more appropriate risk evaluation.

The check unit can optimize evaluation criteria by referring to past precedents and legal data during the check of registrability and trademark infringement risk. The check unit optimizes evaluation criteria by referring to past precedents and legal data during the check of registrability and trademark infringement risk. Past precedents and legal data include, for example, precedent databases and legal documents, but are not limited to these examples. The check unit uses generative AI to analyze past precedents and legal data and optimize evaluation criteria. For example, generative AI refers to precedent databases to adjust evaluation criteria based on similar cases. Additionally, generative AI can refer to legal databases to optimize evaluation criteria based on the latest legal information. Furthermore, generative AI can analyze past trademark infringement cases to improve the accuracy of risk evaluation. For example, generative AI refers to precedent databases to adjust evaluation criteria based on similar cases. Precedent databases include detailed information and content of judgments. Legal databases include legal texts, interpretations, and legal guidelines. Past trademark infringement cases include information on trademark similarity and usage scope. This allows the check unit to optimize evaluation criteria by referring to past precedents and legal data.

The check unit can apply evaluation algorithms specialized for specific industries or markets during the check of registrability and trademark infringement risk. The check unit applies evaluation algorithms specialized for specific industries or markets during the check of registrability and trademark infringement risk. Specific industries or markets include, for example, the IT industry, fashion market, and food industry, but are not limited to these examples. The check unit uses generative AI to apply evaluation algorithms specialized for specific industries or markets. For example, generative AI applies algorithms that emphasize technical elements when checking names for the IT industry. Additionally, generative AI can apply algorithms that emphasize trends and styles when checking names for the fashion industry. Furthermore, generative AI can apply algorithms that emphasize taste and health when checking names for the food industry. For example, generative AI applies algorithms that emphasize technical elements when checking names for the IT industry. Technical elements include, for example, innovation, advancement, and reliability. When checking names for the fashion industry, generative AI applies algorithms that emphasize trends and styles. Trends and styles include, for example, the latest fashion trends, design beauty, and brand image. When checking names for the food industry, generative AI applies algorithms that emphasize taste and health. Taste and health include, for example, good taste, high nutritional value, and health orientation. This allows the check unit to apply evaluation algorithms specialized for specific industries or markets, enabling more appropriate risk evaluation.

The check unit can estimate the user's emotions and determine the priority of check results based on the estimated emotions. The check unit estimates the user's emotions and determines the priority of check results based on the estimated emotions. User emotions include, for example, excitement, anxiety, and relaxation, but are not limited to these examples. The check unit uses facial recognition technology to estimate the user's emotions. For example, the check unit captures the user's facial expressions with a camera and uses facial recognition algorithms to estimate emotions. Additionally, the check unit can use voice analysis technology to estimate the user's emotions. For example, the check unit analyzes the tone and speed of the user's voice to estimate emotions. Furthermore, the check unit can use survey results to estimate the user's emotions. For example, the check unit conducts surveys with users to evaluate emotions. This allows the check unit to determine the priority of check results based on the user's emotions, enabling more appropriate risk evaluation. Emotion estimation is realized using emotion engines or generative AI, such as text-generating AI (e.g., LLM) or multimodal generative AI, but is not limited to these examples. For example, if the user is excited, the generative AI prioritizes displaying low-risk results. Additionally, if the user feels anxious, the generative AI prioritizes displaying high-risk results. Furthermore, if the user is relaxed, the generative AI can prioritize displaying balanced results. This allows the check unit to determine the priority of check results based on the user's emotions, enabling more appropriate risk evaluation.

The check unit can evaluate regional-specific risks by considering the user's geographical location information during the check of registrability and trademark infringement risk. The check unit evaluates regional-specific risks by considering the user's geographical location information during the check of registrability and trademark infringement risk. Geographical location information includes, for example, GPS data, regional-specific culture, and customs, but is not limited to these examples. The check unit uses generative AI to evaluate regional-specific risks by considering the user's geographical location information. For example, if the user is in Japan, generative AI prioritizes referring to Japanese trademark databases to evaluate risks. Additionally, if the user is in the United States, generative AI prioritizes referring to American trademark databases to evaluate risks. Furthermore, if the user is in France, generative AI prioritizes referring to French trademark databases to evaluate risks. For example, if the user is in Japan, generative AI prioritizes referring to Japanese trademark databases to evaluate risks. Japanese trademark databases include information such as trademark registration numbers, registration dates, and registrant names. American trademark databases include information such as trademark registration numbers, registration dates, and registrant names. French trademark databases include information such as trademark registration numbers, registration dates, and registrant names. This allows the check unit to evaluate regional-specific risks by considering the user's geographical location information.

The check unit can analyze the user's social media activities and propose related risks during the check of registrability and trademark infringement risk. The check unit analyzes the user's social media activities and proposes related risks during the check of registrability and trademark infringement risk. Social media activities include, for example, post content, follower count, and engagement rate, but are not limited to these examples. The check unit uses generative AI to analyze the user's social media activities and propose related risks. For example, generative AI analyzes hashtags frequently used by the user and proposes related risks. Additionally, generative AI can analyze the content of accounts followed by the user and propose related risks. Furthermore, generative AI can analyze the user's post content and propose related risks. For example, generative AI analyzes hashtags frequently used by the user and proposes related risks. Hashtags include, for example, keywords related to specific themes or topics. The content of accounts followed by the user includes, for example, fields or topics of interest to the user. Post content includes, for example, information or opinions that the user frequently shares. This allows the check unit to propose related risks by analyzing the user's social media activities.

The organization unit can estimate the user's emotions and adjust the method of organizing application information based on the estimated emotions. The organization unit estimates the user's emotions and adjusts the method of organizing application information based on the estimated emotions. User emotions include, for example, excitement, anxiety, and relaxation, but are not limited to these examples. The organization unit uses facial recognition technology to estimate the user's emotions. For example, the organization unit captures the user's facial expressions with a camera and uses facial recognition algorithms to estimate emotions. Additionally, the organization unit can use voice analysis technology to estimate the user's emotions. For example, the organization unit analyzes the tone and speed of the user's voice to estimate emotions. Furthermore, the organization unit can use survey results to estimate the user's emotions. For example, the organization unit conducts surveys with users to evaluate emotions. This allows the organization unit to adjust the method of organizing application information based on the user's emotions, enabling more appropriate organization of application information. Emotion estimation is realized using emotion engines or generative AI, such as text-generating AI (e.g., LLM) or multimodal generative AI, but is not limited to these examples. For example, if the user is excited, the generative AI provides a simple and intuitive organization method. Additionally, if the user feels anxious, the generative AI provides a detailed and reassuring organization method. Furthermore, if the user is relaxed, the generative AI can provide a balanced organization method. This allows the organization unit to adjust the method of organizing application information based on the user's emotions, enabling more appropriate organization of application information.

The organization unit can select the optimal organization method by referring to past application data during the organization of application information. The organization unit selects the optimal organization method by referring to past application data during the organization of application information. Past application data includes, for example, application history databases and case studies, but is not limited to these examples. The organization unit uses generative AI to analyze past application data and select the optimal organization method. For example, generative AI refers to past successful application data and proposes similar organization methods. Additionally, generative AI can refer to past unsuccessful application data and propose organization methods that avoid similar mistakes. Furthermore, generative AI can dynamically select the optimal organization method by referring to past application databases. For example, generative AI refers to past successful application data and proposes similar organization methods. Application history databases include detailed information and results of applications. Case studies include analyses and evaluations based on specific cases. This allows the organization unit to select the optimal organization method by referring to past application data.

The organization unit can apply organization algorithms specialized for specific industries or markets during the organization of application information. The organization unit applies organization algorithms specialized for specific industries or markets during the organization of application information. Specific industries or markets include, for example, the IT industry, fashion market, and food industry, but are not limited to these examples. The organization unit uses generative AI to apply organization algorithms specialized for specific industries or markets. For example, generative AI applies algorithms that emphasize technical elements when organizing application information for the IT industry. Additionally, generative AI can apply algorithms that emphasize trends and styles when organizing application information for the fashion industry. Furthermore, generative AI can apply algorithms that emphasize taste and health when organizing application information for the food industry. For example, generative AI applies algorithms that emphasize technical elements when organizing application information for the IT industry. Technical elements include, for example, innovation, advancement, and reliability. When organizing application information for the fashion industry, generative AI applies algorithms that emphasize trends and styles. Trends and styles include, for example, the latest fashion trends, design beauty, and brand image. When organizing application information for the food industry, generative AI applies algorithms that emphasize taste and health. Taste and health include, for example, good taste, high nutritional value, and health orientation. This allows the organization unit to apply organization algorithms specialized for specific industries or markets, enabling more appropriate organization of application information.

The organization unit can estimate the user's emotions and determine the priority of application information based on the estimated emotions. The organization unit estimates the user's emotions and determines the priority of application information based on the estimated emotions. User emotions include, for example, excitement, anxiety, and relaxation, but are not limited to these examples. The organization unit uses facial recognition technology to estimate the user's emotions. For example, the organization unit captures the user's facial expressions with a camera and uses facial recognition algorithms to estimate emotions. Additionally, the organization unit can use voice analysis technology to estimate the user's emotions. For example, the organization unit analyzes the tone and speed of the user's voice to estimate emotions. Furthermore, the organization unit can use survey results to estimate the user's emotions. For example, the organization unit conducts surveys with users to evaluate emotions. This allows the organization unit to determine the priority of application information based on the user's emotions, enabling more appropriate organization of application information. Emotion estimation is realized using emotion engines or generative AI, such as text-generating AI (e.g., LLM) or multimodal generative AI, but is not limited to these examples. For example, if the user is excited, the generative AI prioritizes important information at the top of the list. Additionally, if the user feels anxious, the generative AI prioritizes information that provides a sense of security at the top of the list. Furthermore, if the user is relaxed, the generative AI can prioritize balanced information at the top of the list. This allows the organization unit to determine the priority of application information based on the user's emotions, enabling more appropriate organization of application information.

The organization unit can organize regional-specific information by considering the user's geographical location information during the organization of application information. The organization unit organizes regional-specific information by considering the user's geographical location information during the organization of application information. Geographical location information includes, for example, GPS data, regional-specific culture, and customs, but is not limited to these examples. The organization unit uses generative AI to organize regional-specific information by considering the user's geographical location information. For example, if the user is in Japan, generative AI organizes application information based on Japanese legal requirements. Additionally, if the user is in the United States, generative AI organizes application information based on American legal requirements. Furthermore, if the user is in France, generative AI organizes application information based on French legal requirements. For example, if the user is in Japan, generative AI organizes application information based on Japanese legal requirements. Japanese legal requirements include, for example, trademark registration procedures and necessary documents. American legal requirements include, for example, trademark registration procedures and necessary documents. French legal requirements include, for example, trademark registration procedures and necessary documents. This allows the organization unit to organize regional-specific information by considering the user's geographical location information.

The organization unit can analyze the user's social media activities and organize related information during the organization of application information. The organization unit analyzes the user's social media activities and organizes related information during the organization of application information. Social media activities include, for example, post content, follower count, and engagement rate, but are not limited to these examples. The organization unit uses generative AI to analyze the user's social media activities and organize related information. For example, generative AI analyzes hashtags frequently used by the user and organizes related application information. Additionally, generative AI can analyze the content of accounts followed by the user and organize related application information. Furthermore, generative AI can analyze the user's post content and organize related application information. For example, generative AI analyzes hashtags frequently used by the user and organizes related application information. Hashtags include, for example, keywords related to specific themes or topics. The content of accounts followed by the user includes, for example, fields or topics of interest to the user. Post content includes, for example, information or opinions that the user frequently shares. This allows the organization unit to organize related information by analyzing the user's social media activities.

The collection unit can estimate the user's emotions and adjust the method of collecting market research data based on the estimated emotions. The collection unit estimates the user's emotions and adjusts the method of collecting market research data based on the estimated emotions. User emotions include, for example, excitement, anxiety, and relaxation, but are not limited to these examples. The collection unit uses facial recognition technology to estimate the user's emotions. For example, the collection unit captures the user's facial expressions with a camera and uses facial recognition algorithms to estimate emotions. Additionally, the collection unit can use voice analysis technology to estimate the user's emotions. For example, the collection unit analyzes the tone and speed of the user's voice to estimate emotions. Furthermore, the collection unit can use survey results to estimate the user's emotions. For example, the collection unit conducts surveys with users to evaluate emotions. This allows the collection unit to adjust the method of collecting market research data based on the user's emotions, enabling more appropriate data collection. Emotion estimation is realized using emotion engines or generative AI, such as text-generating AI (e.g., LLM) or multimodal generative AI, but is not limited to these examples. For example, if the user is excited, the generative AI prioritizes collecting positive market data. Additionally, if the user feels anxious, the generative AI prioritizes collecting market data to reduce risks. Furthermore, if the user is relaxed, the generative AI can collect balanced market data. This allows the collection unit to adjust the method of collecting market research data based on the user's emotions, enabling more appropriate data collection.

The collection unit can select the optimal collection method by referring to past data during the collection of market research data. The collection unit selects the optimal collection method by referring to past data during the collection of market research data. Past data includes, for example, databases and case studies, but is not limited to these examples. The collection unit uses generative AI to analyze past data and select the optimal collection method. For example, generative AI refers to past successful market research data and proposes similar collection methods. Additionally, generative AI can refer to past unsuccessful market research data and propose collection methods that avoid similar mistakes. Furthermore, generative AI can dynamically select the optimal collection method by referring to past market research databases. For example, generative AI refers to past successful market research data and proposes similar collection methods. Databases include past market research data and analysis results. Case studies include analyses and evaluations based on specific cases. This allows the collection unit to select the optimal collection method by referring to past data.

The collection unit can apply collection algorithms specialized for specific industries or markets during the collection of market research data. The collection unit applies collection algorithms specialized for specific industries or markets during the collection of market research data. Specific industries or markets include, for example, the IT industry, fashion market, and food industry, but are not limited to these examples. The collection unit uses generative AI to apply collection algorithms specialized for specific industries or markets. For example, generative AI applies algorithms that emphasize technical elements when collecting market research data for the IT industry. Additionally, generative AI can apply algorithms that emphasize trends and styles when collecting market research data for the fashion industry. Furthermore, generative AI can apply algorithms that emphasize taste and health when collecting market research data for the food industry. For example, generative AI applies algorithms that emphasize technical elements when collecting market research data for the IT industry. Technical elements include, for example, innovation, advancement, and reliability. When collecting market research data for the fashion industry, generative AI applies algorithms that emphasize trends and styles. Trends and styles include, for example, the latest fashion trends, design beauty, and brand image. When collecting market research data for the food industry, generative AI applies algorithms that emphasize taste and health. Taste and health include, for example, good taste, high nutritional value, and health orientation. This allows the collection unit to apply collection algorithms specialized for specific industries or markets, enabling more appropriate data collection.

The collection unit can estimate the user's emotions and determine the priority of data to be collected based on the estimated emotions. The collection unit estimates the user's emotions and determines the priority of data to be collected based on the estimated emotions. User emotions include, for example, excitement, anxiety, and relaxation, but are not limited to these examples. The collection unit uses facial recognition technology to estimate the user's emotions. For example, the collection unit captures the user's facial expressions with a camera and uses facial recognition algorithms to estimate emotions. Additionally, the collection unit can use voice analysis technology to estimate the user's emotions. For example, the collection unit analyzes the tone and speed of the user's voice to estimate emotions. Furthermore, the collection unit can use survey results to estimate the user's emotions. For example, the collection unit conducts surveys with users to evaluate emotions. This allows the collection unit to determine the priority of data to be collected based on the user's emotions, enabling more appropriate data collection. Emotion estimation is realized using emotion engines or generative AI, such as text-generating AI (e.g., LLM) or multimodal generative AI, but is not limited to these examples. For example, if the user is excited, the generative AI prioritizes positive market data at the top of the list. Additionally, if the user feels anxious, the generative AI prioritizes market data to reduce risks at the top of the list. Furthermore, if the user is relaxed, the generative AI can prioritize balanced market data at the top of the list. This allows the collection unit to determine the priority of data to be collected based on the user's emotions, enabling more appropriate data collection.

The collection unit can prioritize the collection of highly relevant data by considering the user's geographical location information during the collection of market research data. The collection unit prioritizes the collection of highly relevant data by considering the user's geographical location information during the collection of market research data. Geographical location information includes, for example, GPS data, regional-specific culture, and customs, but is not limited to these examples. The collection unit uses generative AI to prioritize the collection of highly relevant data by considering the user's geographical location information. For example, if the user is in Japan, generative AI prioritizes collecting Japanese market data. Additionally, if the user is in the United States, generative AI prioritizes collecting American market data. Furthermore, if the user is in France, generative AI prioritizes collecting French market data. For example, if the user is in Japan, generative AI prioritizes collecting Japanese market data. Japanese market data includes information such as consumer preferences and purchasing behavior. American market data includes information such as consumer preferences and purchasing behavior. French market data includes information such as consumer preferences and purchasing behavior. This allows the collection unit to prioritize the collection of highly relevant data by considering the user's geographical location information.

The collection unit can analyze the user's social media activities and prioritize the collection of related data during the collection of market research data. The collection unit analyzes the user's social media activities and prioritizes the collection of related data during the collection of market research data. Social media activities include, for example, post content, follower count, and engagement rate, but are not limited to these examples. The collection unit uses generative AI to analyze the user's social media activities and prioritize the collection of related data. For example, generative AI analyzes hashtags frequently used by the user and prioritizes collecting related market data. Additionally, generative AI can analyze the content of accounts followed by the user and prioritize collecting related market data. Furthermore, generative AI can analyze the user's post content and prioritize collecting related market data. For example, generative AI analyzes hashtags frequently used by the user and prioritizes collecting related market data. Hashtags include, for example, keywords related to specific themes or topics. The content of accounts followed by the user includes, for example, fields or topics of interest to the user. Post content includes, for example, information or opinions that the user frequently shares. This allows the collection unit to prioritize the collection of related data by analyzing the user's social media activities.

The access unit can estimate the user's emotions and adjust the method of accessing databases based on the estimated emotions. The access unit estimates the user's emotions and adjusts the method of accessing databases based on the estimated emotions. User emotions include, for example, excitement, anxiety, and relaxation, but are not limited to these examples. The access unit uses facial recognition technology to estimate the user's emotions. For example, the access unit captures the user's facial expressions with a camera and uses facial recognition algorithms to estimate emotions. Additionally, the access unit can use voice analysis technology to estimate the user's emotions. For example, the access unit analyzes the tone and speed of the user's voice to estimate emotions. Furthermore, the access unit can use survey results to estimate the user's emotions. For example, the access unit conducts surveys with users to evaluate emotions. This allows the access unit to adjust the method of accessing databases based on the user's emotions, enabling more appropriate database access. Emotion estimation is realized using emotion engines or generative AI, such as text-generating AI (e.g., LLM) or multimodal generative AI, but is not limited to these examples. For example, if the user is excited, the generative AI provides a rapid access method. Additionally, if the user feels anxious, the generative AI provides a detailed access method. Furthermore, if the user is relaxed, the generative AI can provide a balanced access method. This allows the access unit to adjust the method of accessing databases based on the user's emotions, enabling more appropriate database access.

The access unit can select the optimal access method by referring to past access history during database access. The access unit selects the optimal access method by referring to past access history during database access. Past access history includes, for example, access logs and case studies, but is not limited to these examples. The access unit uses generative AI to analyze past access history and select the optimal access method. For example, generative AI refers to past successful access history and proposes similar access methods. Additionally, generative AI can refer to past unsuccessful access history and propose access methods that avoid similar mistakes. Furthermore, generative AI can dynamically select the optimal access method by referring to past access history databases. For example, generative AI refers to past successful access history and proposes similar access methods. Access logs include detailed information and results of past accesses. Case studies include analyses and evaluations based on specific cases. This allows the access unit to select the optimal access method by referring to past access history.

The access unit can apply access algorithms specialized for specific industries or markets during database access. The access unit applies access algorithms specialized for specific industries or markets during database access. Specific industries or markets include, for example, the IT industry, fashion market, and food industry, but are not limited to these examples. The access unit uses generative AI to apply access algorithms specialized for specific industries or markets. For example, generative AI applies algorithms that emphasize technical elements when accessing databases for the IT industry. Additionally, generative AI can apply algorithms that emphasize trends and styles when accessing databases for the fashion industry. Furthermore, generative AI can apply algorithms that emphasize taste and health when accessing databases for the food industry. For example, generative AI applies algorithms that emphasize technical elements when accessing databases for the IT industry. Technical elements include, for example, innovation, advancement, and reliability. When accessing databases for the fashion industry, generative AI applies algorithms that emphasize trends and styles. Trends and styles include, for example, the latest fashion trends, design beauty, and brand image. When accessing databases for the food industry, generative AI applies algorithms that emphasize taste and health. Taste and health include, for example, good taste, high nutritional value, and health orientation. This allows the access unit to apply access algorithms specialized for specific industries or markets, enabling more appropriate database access.

The access unit can estimate the user's emotions and determine the priority of databases to be accessed based on the estimated emotions. The access unit estimates the user's emotions and determines the priority of databases to be accessed based on the estimated emotions. User emotions include, for example, excitement, anxiety, and relaxation, but are not limited to these examples. The access unit uses facial recognition technology to estimate the user's emotions. For example, the access unit captures the user's facial expressions with a camera and uses facial recognition algorithms to estimate emotions. Additionally, the access unit can use voice analysis technology to estimate the user's emotions. For example, the access unit analyzes the tone and speed of the user's voice to estimate emotions. Furthermore, the access unit can use survey results to estimate the user's emotions. For example, the access unit conducts surveys with users to evaluate emotions. This allows the access unit to determine the priority of databases to be accessed based on the user's emotions, enabling more appropriate database access. Emotion estimation is realized using emotion engines or generative AI, such as text-generating AI (e.g., LLM) or multimodal generative AI, but is not limited to these examples. For example, if the user is excited, the generative AI prioritizes accessing important databases. Additionally, if the user feels anxious, the generative AI prioritizes accessing databases that provide a sense of security. Furthermore, if the user is relaxed, the generative AI can prioritize accessing balanced databases. This allows the access unit to determine the priority of databases to be accessed based on the user's emotions, enabling more appropriate database access.

The access unit can prioritize access to highly relevant databases by considering the user's geographical location information during database access. The access unit prioritizes access to highly relevant databases by considering the user's geographical location information during database access. Geographical location information includes, for example, GPS data, regional-specific culture, and customs, but is not limited to these examples. The access unit uses generative AI to prioritize access to highly relevant databases by considering the user's geographical location information. For example, if the user is in Japan, generative AI prioritizes accessing Japanese databases. Additionally, if the user is in the United States, generative AI prioritizes accessing American databases. Furthermore, if the user is in France, generative AI prioritizes accessing French databases. For example, if the user is in Japan, generative AI prioritizes accessing Japanese databases. Japanese databases include information such as trademark registration and registration information. American databases include information such as trademark registration and registration information. French databases include information such as trademark registration and registration information. This allows the access unit to prioritize access to highly relevant databases by considering the user's geographical location information.

The access unit can analyze the user's social media activities and prioritize access to related databases during database access. The access unit analyzes the user's social media activities and prioritizes access to related databases during database access. Social media activities include, for example, post content, follower count, and engagement rate, but are not limited to these examples. The access unit uses generative AI to analyze the user's social media activities and prioritize access to related databases. For example, generative AI analyzes hashtags frequently used by the user and prioritizes access to related databases. Additionally, generative AI can analyze the content of accounts followed by the user and prioritize access to related databases. Furthermore, generative AI can analyze the user's post content and prioritize access to related databases. For example, generative AI analyzes hashtags frequently used by the user and prioritizes access to related databases. Hashtags include, for example, keywords related to specific themes or topics. The content of accounts followed by the user includes, for example, fields or topics of interest to the user. Post content includes, for example, information or opinions that the user frequently shares. This allows the access unit to prioritize access to related databases by analyzing the user's social media activities.

The listing unit can estimate the user's emotions and adjust the method of listing based on the estimated emotions. The listing unit estimates the user's emotions and adjusts the method of listing based on the estimated emotions. User emotions include, for example, excitement, anxiety, and relaxation, but are not limited to these examples. The listing unit uses facial recognition technology to estimate the user's emotions. For example, the listing unit captures the user's facial expressions with a camera and uses facial recognition algorithms to estimate emotions. Additionally, the listing unit can use voice analysis technology to estimate the user's emotions. For example, the listing unit analyzes the tone and speed of the user's voice to estimate emotions. Furthermore, the listing unit can use survey results to estimate the user's emotions. For example, the listing unit conducts surveys with users to evaluate emotions. This allows the listing unit to adjust the method of listing based on the user's emotions, enabling more appropriate listing. Emotion estimation is realized using emotion engines or generative AI, such as text-generating AI (e.g., LLM) or multimodal generative AI, but is not limited to these examples. For example, if the user is excited, the generative AI provides a simple and intuitive listing method. Additionally, if the user feels anxious, the generative AI provides a detailed and reassuring listing method. Furthermore, if the user is relaxed, the generative AI can provide a balanced listing method. This allows the listing unit to adjust the method of listing based on the user's emotions, enabling more appropriate listing.

The listing unit can select the optimal listing method by referring to past listing data during listing. The listing unit selects the optimal listing method by referring to past listing data during listing. Past listing data includes, for example, databases and case studies, but is not limited to these examples. The listing unit uses generative AI to analyze past listing data and select the optimal listing method. For example, generative AI refers to past successful listing data and proposes similar listing methods. Additionally, generative AI can refer to past unsuccessful listing data and propose listing methods that avoid similar mistakes. Furthermore, generative AI can dynamically select the optimal listing method by referring to past listing databases. For example, generative AI refers to past successful listing data and proposes similar listing methods. Databases include past listing data and analysis results. Case studies include analyses and evaluations based on specific cases. This allows the listing unit to select the optimal listing method by referring to past listing data.

The listing unit can apply listing algorithms specialized for specific industries or markets during listing. The listing unit applies listing algorithms specialized for specific industries or markets during listing. Specific industries or markets include, for example, the IT industry, fashion market, and food industry, but are not limited to these examples. The listing unit uses generative AI to apply listing algorithms specialized for specific industries or markets. For example, generative AI applies algorithms that emphasize technical elements when listing for the IT industry. Additionally, generative AI can apply algorithms that emphasize trends and styles when listing for the fashion industry. Furthermore, generative AI can apply algorithms that emphasize taste and health when listing for the food industry. For example, generative AI applies algorithms that emphasize technical elements when listing for the IT industry. Technical elements include, for example, innovation, advancement, and reliability. When listing for the fashion industry, generative AI applies algorithms that emphasize trends and styles. Trends and styles include, for example, the latest fashion trends, design beauty, and brand image. When listing for the food industry, generative AI applies algorithms that emphasize taste and health. Taste and health include, for example, good taste, high nutritional value, and health orientation. This allows the listing unit to apply listing algorithms specialized for specific industries or markets, enabling more appropriate listing.

The listing unit can estimate the user's emotions and determine the priority of items to be listed based on the estimated emotions. The listing unit estimates the user's emotions and determines the priority of items to be listed based on the estimated emotions. User emotions include, for example, excitement, anxiety, and relaxation, but are not limited to these examples. The listing unit uses facial recognition technology to estimate the user's emotions. For example, the listing unit captures the user's facial expressions with a camera and uses facial recognition algorithms to estimate emotions. Additionally, the listing unit can use voice analysis technology to estimate the user's emotions. For example, the listing unit analyzes the tone and speed of the user's voice to estimate emotions. Furthermore, the listing unit can use survey results to estimate the user's emotions. For example, the listing unit conducts surveys with users to evaluate emotions. This allows the listing unit to determine the priority of items to be listed based on the user's emotions, enabling more appropriate listing. Emotion estimation is realized using emotion engines or generative AI, such as text-generating AI (e.g., LLM) or multimodal generative AI, but is not limited to these examples. For example, if the user is excited, the generative AI prioritizes important items at the top of the list. Additionally, if the user feels anxious, the generative AI prioritizes items that provide a sense of security at the top of the list. Furthermore, if the user is relaxed, the generative AI can prioritize balanced items at the top of the list. This allows the listing unit to determine the priority of items to be listed based on the user's emotions, enabling more appropriate listing.

The listing unit can prioritize the listing of highly relevant items by considering the user's geographical location information during listing. The listing unit prioritizes the listing of highly relevant items by considering the user's geographical location information during listing. Geographical location information includes, for example, GPS data, regional-specific culture, and customs, but is not limited to these examples. The listing unit uses generative AI to prioritize the listing of highly relevant items by considering the user's geographical location information. For example, if the user is in Japan, generative AI lists items based on Japanese legal requirements. Additionally, if the user is in the United States, generative AI lists items based on American legal requirements. Furthermore, if the user is in France, generative AI lists items based on French legal requirements. For example, if the user is in Japan, generative AI lists items based on Japanese legal requirements. Japanese legal requirements include, for example, trademark registration procedures and necessary documents. American legal requirements include, for example, trademark registration procedures and necessary documents. French legal requirements include, for example, trademark registration procedures and necessary documents. This allows the listing unit to prioritize the listing of highly relevant items by considering the user's geographical location information.

The listing unit can analyze the user's social media activities and prioritize the listing of related items during listing. The listing unit analyzes the user's social media activities and prioritizes the listing of related items during listing. Social media activities include, for example, post content, follower count, and engagement rate, but are not limited to these examples. The listing unit uses generative AI to analyze the user's social media activities and prioritize the listing of related items. For example, generative AI analyzes hashtags frequently used by the user and prioritizes the listing of related items. Additionally, generative AI can analyze the content of accounts followed by the user and prioritize the listing of related items. Furthermore, generative AI can analyze the user's post content and prioritize the listing of related items. For example, generative AI analyzes hashtags frequently used by the user and prioritizes the listing of related items. Hashtags include, for example, keywords related to specific themes or topics. The content of accounts followed by the user includes, for example, fields or topics of interest to the user. Post content includes, for example, information or opinions that the user frequently shares. This allows the listing unit to prioritize the listing of related items by analyzing the user's social media activities.

The system according to the embodiment is not limited to the examples described above and can be modified in various ways, such as the following.

The analysis unit can also evaluate the phonetic characteristics of names during the analysis of name appropriateness. For example, it evaluates how the sound and rhythm of names are perceived in specific cultures or languages. This allows the determination of whether names are easy to pronounce and remember. Additionally, the analysis unit can use speech recognition technology to evaluate the phonetic characteristics of names. For example, it analyzes the pronunciation of names using speech recognition technology to evaluate the difficulty of pronunciation. Furthermore, the analysis unit can refer to phonetic databases to evaluate the phonetic characteristics of names. For example, phonetic databases include phonetic patterns and pronunciation rules of various languages. This allows the analysis unit to evaluate the phonetic characteristics of names, providing more appropriate name candidates.

The collection unit can also collect data in real-time during the collection of market research data. For example, it collects social media trends and news articles in real-time and uses them as data to evaluate the appropriateness of names. Additionally, the collection unit can provide real-time collected data to the analysis unit to dynamically adjust name evaluation criteria. Furthermore, the collection unit can provide real-time collected data to users and propose name candidates that reflect the latest market trends. For example, the collection unit collects social media trends in real-time and proposes name candidates. This allows the collection unit to provide more appropriate name candidates by collecting data in real-time.

The access unit can also consider the update frequency of databases when accessing trademark databases and registration databases of various countries. For example, if databases are frequently updated, it increases the access frequency to obtain the latest information. Additionally, the access unit can dynamically adjust the access schedule based on the update frequency of databases. Furthermore, the access unit can provide the latest information to users based on the update frequency of databases. For example, if databases are updated daily, the access unit accesses them daily to obtain the latest information. This allows the access unit to provide more accurate information by considering the update frequency of databases.

The listing unit can also refer to the user's past procedural history when listing necessary documents and procedural steps. For example, it automatically lists similar procedures if the user has previously conducted similar procedures. Additionally, the listing unit can optimize procedural steps based on the user's past procedural history. Furthermore, the listing unit can automatically generate necessary documents by referring to the user's past procedural history. For example, the listing unit refers to the user's past procedural history and automatically generates necessary documents. This allows the listing unit to streamline procedures by referring to the user's past procedural history.

The analysis unit can estimate the user's emotions and adjust the evaluation criteria for name candidates based on the estimated emotions. For example, if the user is excited, the generative AI prioritizes names with positive meanings and images. Additionally, if the user feels anxious, the generative AI prioritizes names that provide a sense of security. Furthermore, if the user is relaxed, the generative AI prioritizes names with a soft sound. This allows the analysis unit to adjust the evaluation criteria for names based on the user's emotions, providing more appropriate name candidates.

The analysis unit can optimize evaluation criteria by referring to past successful and unsuccessful cases during name analysis. For example, generative AI analyzes the characteristics of names that have been successful in the past and highly evaluates names with similar characteristics. Additionally, generative AI analyzes the characteristics of names that have failed in the past and can evaluate names with similar characteristics lower. Furthermore, generative AI can dynamically adjust evaluation criteria by referring to databases of successful and unsuccessful cases. This allows the analysis unit to optimize evaluation criteria by referring to past cases.

The analysis unit can apply evaluation algorithms specialized for specific industries or markets during name analysis. For example, generative AI applies algorithms that emphasize technical images when analyzing names for the IT industry. Additionally, generative AI can apply algorithms that emphasize trends and styles when analyzing names for the fashion industry. Furthermore, generative AI can apply algorithms that emphasize taste and health when analyzing names for the food industry. This allows the analysis unit to apply evaluation algorithms specialized for specific industries or markets, providing more appropriate name candidates.

The analysis unit can estimate the user's emotions and determine the priority of name candidates based on the estimated emotions. For example, if the user is excited, the generative AI prioritizes names with positive meanings and images at the top of the list. Additionally, if the user feels anxious, the generative AI prioritizes names that provide a sense of security at the top of the list. Furthermore, if the user is relaxed, the generative AI can prioritize names with a soft sound at the top of the list. This allows the analysis unit to determine the priority of name candidates based on the user's emotions, providing more appropriate name candidates.

The analysis unit can evaluate regional-specific meanings and images based on the user's geographical location information during name analysis. For example, generative AI emphasizes Japanese meanings and images when evaluating names if the user is in Japan. Additionally, generative AI can emphasize English meanings and images when evaluating names if the user is in the United States. Furthermore, generative AI can emphasize French meanings and images when evaluating names if the user is in France. This allows the analysis unit to evaluate regional-specific meanings and images by considering the user's geographical location information.

The analysis unit can analyze the user's social media activities and propose related name candidates during name analysis. For example, generative AI analyzes hashtags frequently used by the user and proposes related name candidates. Additionally, generative AI can analyze the content of accounts followed by the user and propose related name candidates. Furthermore, generative AI can analyze the user's post content and propose related name candidates. This allows the analysis unit to propose related name candidates by analyzing the user's social media activities.

The following briefly explains the process flow of Example 2 of the Embodiment.

Step 1: The analysis unit analyzes the appropriateness of names. The appropriateness of names includes cultural compatibility, ease of pronunciation, and appropriateness of meaning. The analysis unit uses generative AI to analyze the meaning and image of names and further evaluates them by referring to market research data and databases of various countries.

Step 2: The check unit checks the registrability in various countries and the risk of trademark infringement based on name candidates generated by the analysis unit. The check unit accesses trademark databases and registration databases of various countries through related APIs to confirm whether the input name is already registered or poses a risk of trademark infringement.

Step 3: The organization unit organizes application information for registration and trademark registration based on the results obtained by the check unit. The organization unit lists necessary documents and procedural steps and provides them to the user.

The specific processing unit 290 sends the results of specific processing to the smart device 14. In the smart device 14, the control unit 46A outputs the results of specific processing to the output device 40. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the multiple elements including the aforementioned analysis unit, check unit, organization unit, collection unit, access unit, and listing unit is realized by at least one of the smart device 14 and the data processing device 12, for example. For instance, the analysis unit is realized by the control unit 46A of the smart device 14 and analyzes the appropriateness of names. The check unit is realized by the specific processing unit 290 of the data processing device 12, for example, and checks the registrability and trademark infringement risk in various countries. The organization unit is realized by the control unit 46A of the smart device 14, for example, and organizes application information for registration and trademark registration. The collection unit is realized by the specific processing unit 290 of the data processing device 12, for example, and collects market research data. The access unit is realized by the control unit 46A of the smart device 14, for example, and accesses trademark databases and registration databases of various countries. The listing unit is realized by the specific processing unit 290 of the data processing device 12, for example, and lists necessary documents and procedural steps. The correspondence between each unit and the device or control unit is not limited to the examples described above, and various modifications are possible.

### Second Embodiment

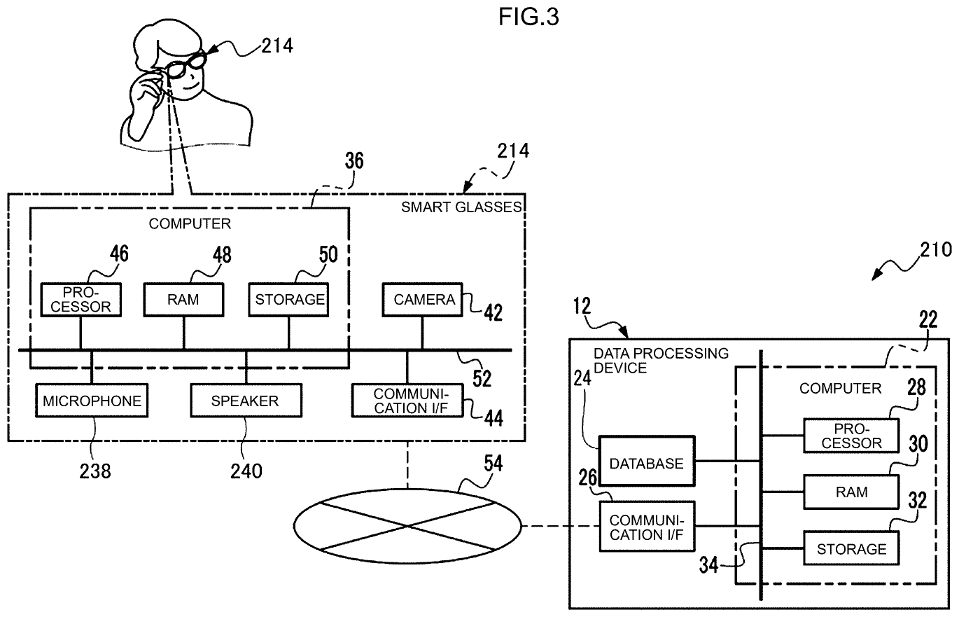

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

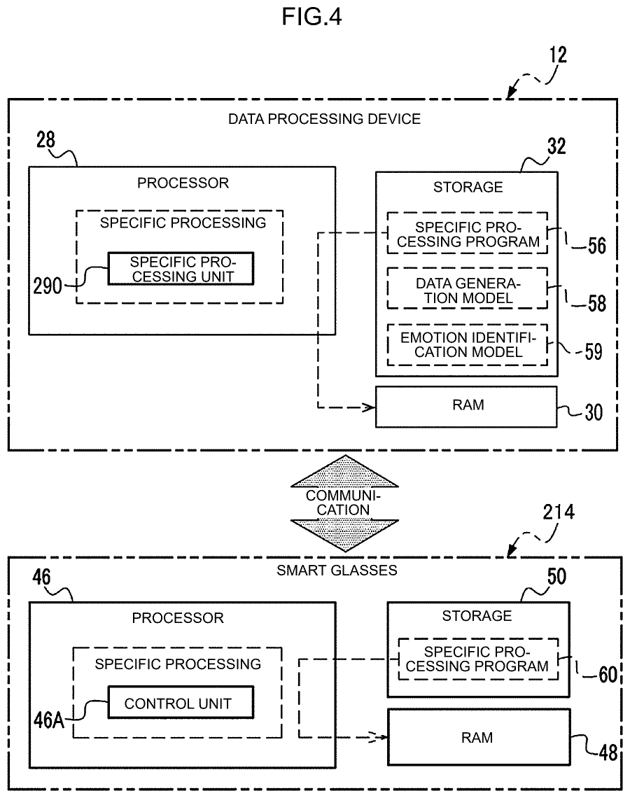

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the multiple elements including the aforementioned analysis unit, check unit, organization unit, collection unit, access unit, and listing unit is realized by at least one of the smart glasses 214 and the data processing device 12, for example. For instance, the analysis unit is realized by the control unit 46A of the smart glasses 214 and analyzes the appropriateness of names. The check unit is realized by the specific processing unit 290 of the data processing device 12, for example, and checks the registrability and trademark infringement risk in various countries. The organization unit is realized by the control unit 46A of the smart glasses 214, for example, and organizes application information for registration and trademark registration. The collection unit is realized by the specific processing unit 290 of the data processing device 12, for example, and collects market research data. The access unit is realized by the control unit 46A of the smart glasses 214, for example, and accesses trademark databases and registration databases of various countries. The listing unit is realized by the specific processing unit 290 of the data processing device 12, for example, and lists necessary documents and procedural steps. The correspondence between each unit and the device or control unit is not limited to the examples described above, and various modifications are possible.

### Third Embodiment

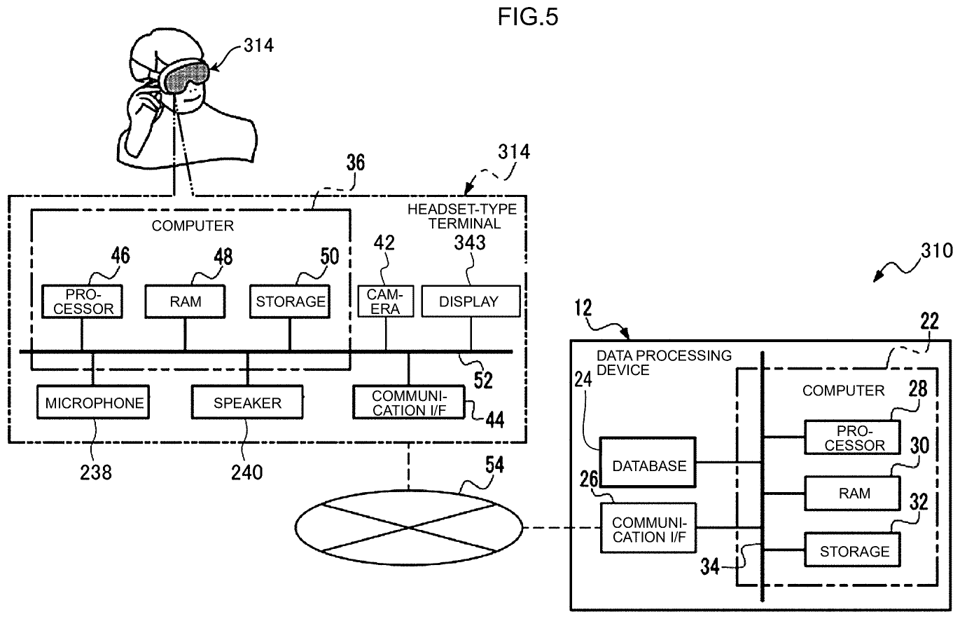

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

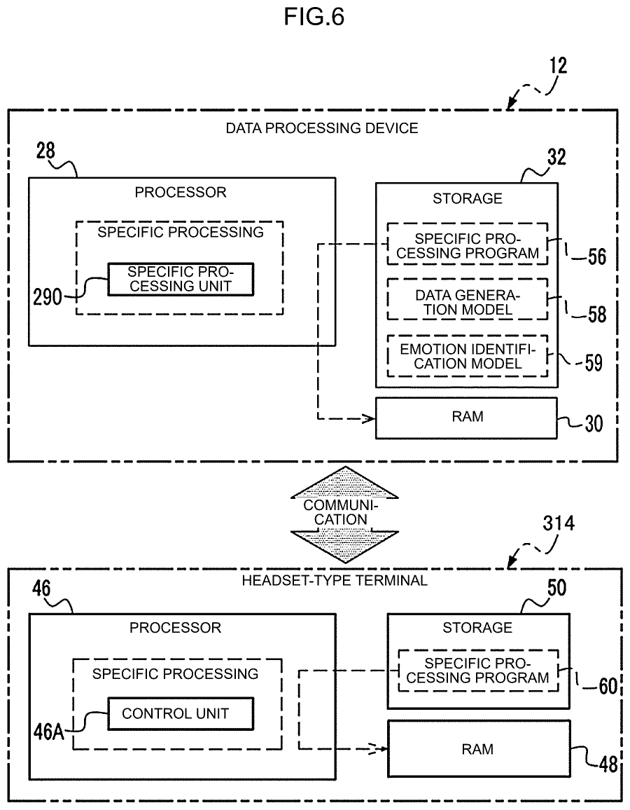

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the multiple elements including the aforementioned analysis unit, check unit, organization unit, collection unit, access unit, and listing unit is realized by at least one of the headset-type terminal 314 and the data processing device 12, for example. For instance, the analysis unit is realized by the control unit 46A of the headset-type terminal 314 and analyzes the appropriateness of names. The check unit is realized by the specific processing unit 290 of the data processing device 12, for example, and checks the registrability and trademark infringement risk in various countries. The organization unit is realized by the control unit 46A of the headset-type terminal 314, for example, and organizes application information for registration and trademark registration. The collection unit is realized by the specific processing unit 290 of the data processing device 12, for example, and collects market research data. The access unit is realized by the control unit 46A of the headset-type terminal 314, for example, and accesses trademark databases and registration databases of various countries. The listing unit is realized by the specific processing unit 290 of the data processing device 12, for example, and lists necessary documents and procedural steps. The correspondence between each unit and the device or control unit is not limited to the examples described above, and various modifications are possible.

### Fourth Embodiment

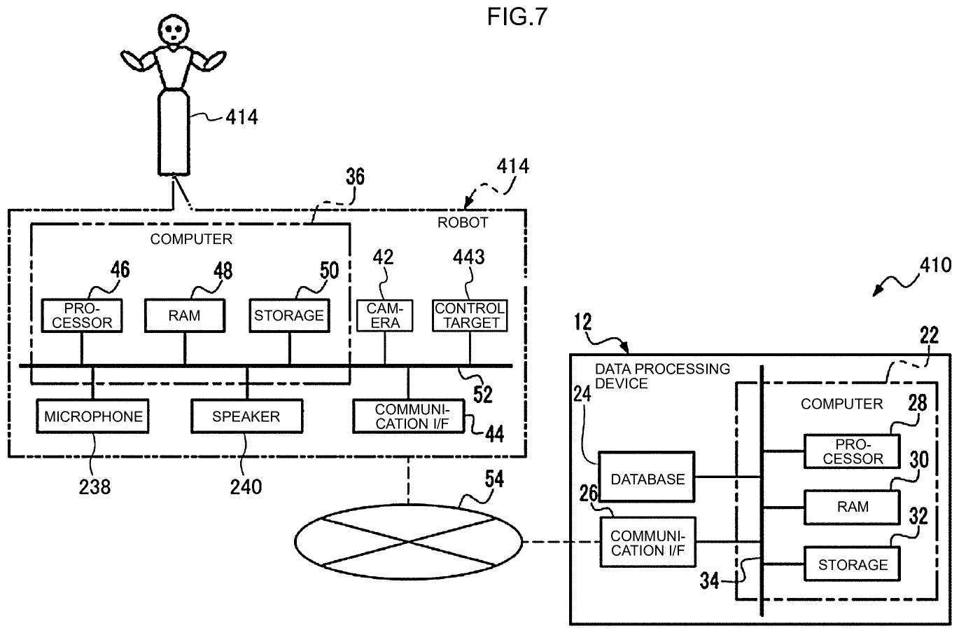

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

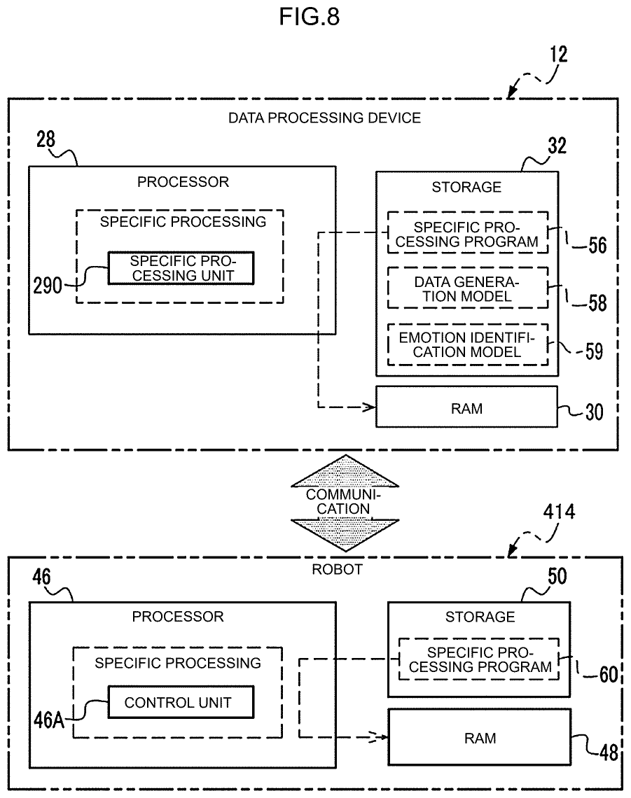

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the multiple elements including the aforementioned analysis unit, check unit, organization unit, collection unit, access unit, and listing unit is realized by at least one of the robot 414 and the data processing device 12, for example. For instance, the analysis unit is realized by the control unit 46A of the robot 414 and analyzes the appropriateness of names. The check unit is realized by the specific processing unit 290 of the data processing device 12, for example, and checks the registrability and trademark infringement risk in various countries. The organization unit is realized by the control unit 46A of the robot 414, for example, and organizes application information for registration and trademark registration. The collection unit is realized by the specific processing unit 290 of the data processing device 12, for example, and collects market research data. The access unit is realized by the control unit 46A of the robot 414, for example, and accesses trademark databases and registration databases of various countries. The listing unit is realized by the specific processing unit 290 of the data processing device 12, for example, and lists necessary documents and procedural steps. The correspondence between each unit and the device or control unit is not limited to the examples described above, and various modifications are possible.

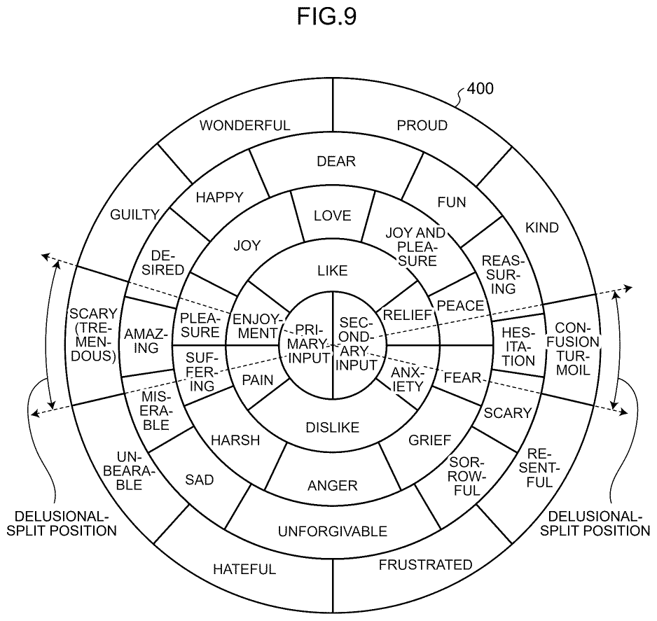

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

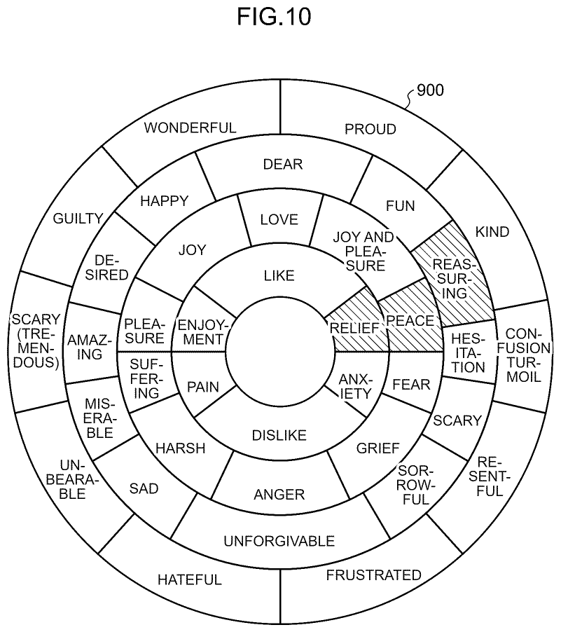

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used. Additionally, the examples described above were explained by dividing into form example 1 and form example 2, but these may be combined.

The system according to the embodiments consistently checks appropriateness of a name, registrability in various countries, and trademark infringement risk, so that it is possible to streamline procedures.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

### [Additional Note 1]

A system comprising:
an analysis unit that analyzes appropriateness of a name;
a check unit that checks registrability in various countries or risk of trademark infringement based on name candidates generated by the analysis unit; and
an organization unit that organizes application information for registration or trademark registration based on a result obtained by the check unit.

### [Additional Note 2]

The system according to Additional Note 1, further comprising:
a collection unit that collects market research data.

### [Additional Note 3]

The system according to Additional Note 1, further comprising:
an access unit that accesses trademark databases and registration databases of various countries.

### [Additional Note 4]

The system according to Additional Note 1, further comprising:
a listing unit that lists necessary documents and procedural steps.

### [Additional Note 5]

The system according to Additional Note 1, wherein the analysis unit estimates user's emotions, and adjusts a evaluation criteria for name candidates based on the estimated emotions.

### [Additional Note 6]

The system according to Additional Note 1, wherein the analysis unit optimizes an evaluation criteria by referring to past successful and unsuccessful cases during name analysis.

### [Additional Note 7]

The system according to Additional Note 1, wherein the analysis unit applies an evaluation algorithm specialized for a specific industry or market during name analysis.

### [Additional Note 8]

The system according to Additional Note 1, wherein the analysis unit estimates user's emotions, and determines a priority of a name candidate based on the estimated emotions.

### [Additional Note 9]

The system according to Additional Note 1, wherein the analysis unit evaluates a regional-specific meaning and image based on user's geographical location information during name analysis.

### [Additional Note 10]

The system according to Additional Note 1, wherein the analysis unit analyzes a user's social media activity, and proposes a name candidate during name analysis.

### [Additional Note 11]

The system according to Additional Note 1, wherein the check unit estimates user's emotions, and adjusts an evaluation criteria for registrability and trademark infringement risk based on the estimated emotions.

### [Additional Note 12]

The system according to Additional Note 1, wherein the check unit optimizes an evaluation criteria by referring to past precedents and legal data during the check of registrability and trademark infringement risk.

### [Additional Note 13]

The system according to Additional Note 1, wherein the check unit applies an evaluation algorithm specialized for a specific industry or market during the check of registrability and trademark infringement risk.

### [Additional Note 14]

The system according to Additional Note 1, wherein the check unit estimates user's emotions, and determines a priority of check results based on the estimated emotions.

### [Additional Note 15]

The system according to Additional Note 1, wherein the check unit evaluates a regional-specific risk by considering user's geographical location information during the check of registrability and trademark infringement risk.

### [Additional Note 16]

The system according to Additional Note 1, wherein the check unit analyzes a user's social media activity, and proposes related risks during the check of registrability and trademark infringement risk.

### [Additional Note 17]

The system according to Additional Note 1, wherein the organization unit estimates user's emotions, and adjusts a method of organizing application information based on the estimated emotions.

### [Additional Note 18]

The system according to Additional Note 1, wherein the organization unit selects an optimal organization method by referring to past application data during organization of application information.

### [Additional Note 19]

The system according to Additional Note 1, wherein the organization unit applies an organization algorithm specialized for a specific industry or market during organization of application information.

### [Additional Note 20]

The system according to Additional Note 1, wherein the organization unit estimates user's emotions, and determines a priority of application information based on the estimated emotions.

### [Additional Note 21]

The system according to Additional Note 1, wherein the organization unit organizes regional-specific information by considering user's geographical location information during organization of application information.

### [Additional Note 22]

The system according to Additional Note 1, wherein the organization unit analyzes a user's social media activity, and organizes related information during organization of application information.

### [Additional Note 23]

The system according to Additional Note 2, wherein the collection unit estimates user's emotions, and adjusts a method of collecting market research data based on the estimated emotions.

### [Additional Note 24]

The system according to Additional Note 2, wherein the collection unit selects a optimal collection method by referring to past data during collection of market research data.

### [Additional Note 25]

The system according to Additional Note 2, wherein the collection unit applies a collection algorithm specialized for a specific industry or market during collection of market research data.

### [Additional Note 26]

The system according to Additional Note 2, wherein the collection unit estimates user's emotions, and determines a priority of data to be collected based on the estimated emotions.

### [Additional Note 27]

The system according to Additional Note 2, wherein the collection unit prioritizes collection of highly relevant data by considering user's geographical location information during collection of market research data.

### [Additional Note 28]

The system according to Additional Note 2, wherein the collection unit analyzes a user's social media activity, and prioritizes collection of related data during collection of market research data.

### [Additional Note 29]

The system according to Additional Note 3, wherein the access unit estimates user's emotions, and adjusts a method of accessing databases based on the estimated emotions.

### [Additional Note 30]

The system according to Additional Note 3, wherein the access unit selects an optimal access method by referring to a past access history during database access.

### [Additional Note 31]

The system according to Additional Note 3, wherein the access unit applies an access algorithm specialized for a specific industry or market during database access.

### [Additional Note 32]

The system according to Additional Note 3, wherein the access unit estimates user's emotions, and determines a priority of databases to be accessed based on the estimated emotions.

### [Additional Note 33]

The system according to Additional Note 3, wherein the access unit prioritizes access to a highly relevant database by considering user's geographical location information during database access.

### [Additional Note 34]

The system according to Additional Note 3, wherein the access unit analyzes a user's social media activity, and prioritizes access to a related database during database access.

### [Additional Note 35]

The system according to Additional Note 4, wherein the listing unit estimates user's emotions, and adjusts a method of listing based on the estimated emotions.

### [Additional Note 36]

The system according to Additional Note 4, wherein the listing unit selects an optimal listing method by referring to past listing data during listing.

### [Additional Note 37]

The system according to Additional Note 4, wherein the listing unit applies a listing algorithm specialized for a specific industry or market during listing.

### [Additional Note 38]

The system according to Additional Note 4, wherein the listing unit estimates user's emotions, and determines priority of items to be listed based on the estimated emotions.

### [Additional Note 39]

The system according to Additional Note 4, wherein the listing unit prioritizes listing of highly relevant items by considering user's geographical location information during listing.

### [Additional Note 40]

The system according to Additional Note 4, wherein the listing unit analyzes a user's social media activity, and prioritizes listing of related items during listing.

What is claimed is:

1. A system comprising:
an analysis unit that analyzes appropriateness of a name;
a check unit that checks registrability in various countries or a risk of trademark infringement based on name candidates generated by the analysis unit; and
an organization unit that organizes application information for registration or trademark registration based on a result obtained by the check unit.

2. The system according to claim 1, further comprising:
a collection unit that collects market research data.

3. The system according to claim 1, further comprising:
an access unit that accesses trademark databases and registration databases of various countries.

4. The system according to claim 1, further comprising:
a listing unit that lists necessary documents and procedural steps.

5. The system according to claim 1, wherein
the analysis unit estimates user's emotions, and adjusts an evaluation criteria for name candidates based on the estimated emotions.

6. The system according to claim 1, wherein
the analysis unit optimizes an evaluation criteria by referring to past successful and unsuccessful cases during name analysis.

7. The system according to claim 1, wherein
the analysis unit applies an evaluation algorithm specialized for a specific industry or market during name analysis.

8. The system according to claim 1, wherein
the analysis unit estimates user's emotions, and determines priority of name candidates based on the estimated emotions.

9. The system according to claim 1, wherein
the analysis unit evaluates regional-specific meaning and image based on user's geographical location information during name analysis.
